(19) United States
(12) Patent Application Publication
(10) Pub. No.: US 2022/0375359 A1
(43) Pub. Date: Nov. 24, 2022

(54) INTERACTIVE MEDIA

(71) Applicant: TA-DA! LANGUAGE PRODUCTIONS, INC., Los Altos, CA (US)

(72) Inventors: Jesse Daniel Lewis, Los Altos, CA (US); Leigh Michelle Glorieux, Los Altos, CA (US); Bert Remi Jeannine Glorieux, Los Altos, CA (US)

(21) Appl. No.: 17/715,772

(22) Filed: Apr. 7, 2022

Related U.S. Application Data
(63) Continuation of application No. PCT/US2020/054622, filed on Oct. 7, 2020.
(60) Provisional application No. 62/912,562, filed on Oct. 8, 2019.

(51) Int. Cl. G09B 5/06; B42D 1/00; G06F 3/16; G06F 3/044

(52) U.S. Cl. CPC G09B 5/062; B42D 1/009; G06F 3/167; G06F 3/0446

(57) ABSTRACT

Disclosed herein are devices and methods for an interactive book configured to enhance a user's vocabulary. In some embodiments, an interactive paper-based book comprises a back cover comprising a plurality of touch sensors and an audio module and a plurality of paper pages that are stacked together on top of each other. In some embodiments, each of the pages comprises a grid array of images associated with a plurality of words. In some embodiments, the grid array of images on the plurality of pages are aligned with the plurality of touch sensors on the back cover. In some embodiments, each of the pages and a set of audio files for each page are configured to be activated using a page button corresponding to the respective page. In some embodiments, the page buttons are located on one or more portions of the book. In some embodiments, the audio module is configured to play one or more sounds associated with an image on an activated page when the user touches the image on the activated page.

### CROSS-REFERENCE

This application is a continuation application of International Application No. PCT/US2020/054622, filed Oct. 7, 2020, which claims the benefit of U.S. Provisional Application No. 62/912,562, filed Oct. 8, 2019, which is incorporated by reference herein in its entirety.

### BACKGROUND

Interactive media can provide a stimulating environment for a user when learning or developing a skill. For example, increasing a child's vocabulary is a seminal process as part of the child's growth and development. Enhancing the development of a child's vocabulary often require stimulating exercises to help keep a child engaged when learning and processing new words. Interactive activities, such as through interactive books and other media provide a platform that helps teach children to learn and expand their vocabulary while keeping a child focused and engaged with a given activity.

This application claims priority to U.S. Provisional Application No. 62/912,562, filed Oct. 8, 2019, which is incorporated by reference herein in its entirety.

### SUMMARY

The present disclosure is directed to interactive media. The interactive media may be in the form of books, posters, pamphlets, brochures, handouts, and the like. Images and text may be printed on paper, cardboard, or other types of materials such as canvas, linen, leather, and the like. The interactive paper media may comprise electronics that are configured to emit audio and/or visual signals for enhancing user experience and/or for improving learning when used in an educational context.

Disclosed herein, in some embodiments is an interactive paper-based book comprising: a back cover comprising a plurality of touch sensors and an audio module; and a plurality of paper pages that are stacked together on top of each other, wherein each of the pages comprises a grid array of images associated with a plurality of words, wherein the grid array of images on the plurality of pages are aligned with the plurality of touch sensors on the back cover, wherein each of the pages and a set of audio files for each page are configured to be activated using a page button corresponding to the respective page, wherein the page buttons are located on one or more portions of the book, and wherein the audio module is configured to play one or more sounds associated with an image on an activated page when the user touches the image on the activated page.

In some embodiments, the plurality of touch sensors are disposed on a touch sensor substrate. In some embodiments, the plurality of touch sensors are in electrical communication with the audio module. In some embodiments, the plurality of touch sensors are in electrical communication with the audio module through electric circuitry. In some embodiments, the plurality of touch sensors are in electrical communication with the audio module using conductive ink. In some embodiments, the conductive ink a metallic-based ink. In some embodiments, the conductive ink comprises silver-based conductive ink, copper-based ink, a carbon-based ink. In some embodiments, one or more touch sensors of the plurality of touch sensors comprises a capacitive touch element. In some embodiments, the audio module comprises a printed circuit board (PCB). In some embodiments, the audio module comprises a flexible circuit board. In some embodiments, the audio module comprises a memory module and processor. In some embodiments, the audio module is configured to play the one or more sounds using a speaker. In some embodiments, the speaker is disposed within the back cover. In some embodiments, the back cover comprises one or more speaker holes. In some embodiments, at least one speaker hole of the one or more speaker holes is not visible external to the back cover, wherein the speaker hole(s) that are not visible is configured to provide diaphragmatic resonance of the one or more sounds. In some embodiments, each page button corresponds to a touch sensor. In some embodiments, the one or more sounds are audio mastered. In some embodiments, the grid array comprises an “m”×“n” format, wherein “m” represents a predetermined number of rows, and “n” represents a predetermined number of columns. In some embodiments, the grid array comprises a square grid array, wherein the number of rows is equal to the number of columns. In some embodiments, the grid array comprises a rectangular grid array, wherein the number of rows is different from the number of columns. In some embodiments, the grid array comprises from about 5 rows to about 20 rows, and from about 4 columns to about 16 columns. In some embodiments, the plurality of paper pages comprises at least about 5 paper pages. In some embodiments, the plurality of paper pages comprises at least about 10 paper pages. In some embodiments, the plurality of paper pages comprises at least about 20 paper pages. In some embodiments, the interactive paper-based book further comprises at least about 500, 1000, 10000, or 50000 images.

Disclosed herein, in some embodiments, is an interactive paper-based book comprising: a back cover comprising an audio module; a plurality of paper pages that are stacked together on top of each other; and a plurality of touch sensors, where each paper page comprises a subset of the plurality of touch sensors disposed thereon, wherein each of the pages comprises a grid array of images associated with a plurality of words, wherein for each page, each image of the corresponding grid array of images is aligned with a corresponding touch sensor, wherein each touch sensor is in electrical communication with the audio module; wherein each of the pages and a set of audio files for each page are configured to be activated using a page button corresponding to the respective page, wherein the page buttons are located on one or more portions of the book, and wherein the audio module is configured to play one or more sounds associated with an image on an activated page when the user touches the image on the activated page.

In some embodiments, the plurality of touch sensors are embedded with the plurality of paper pages. In some embodiments, the plurality of touch sensors are in electrical communication with the audio module. In some embodiments, the plurality of touch sensors are in electrical communication with the audio module through electric circuitry. In some embodiments, the plurality of touch sensors are in electrical communication with the audio module using conductive ink. In some embodiments, the conductive ink a metallic-based ink. In some embodiments, the conductive ink comprises silver-based conductive ink, copper-based ink, a carbon-based ink. In some embodiments, the electric circuitry of the plurality of touch sensors from each page travels through a spine of the interactive book so as to be in electrical communication with the audio module. In some embodiments, one or more touch sensors of the plurality of touch sensors comprises a capacitive touch element. In some embodiments, the audio module comprises a printed circuit board (PCB). In some embodiments, the audio module comprises a flexible circuit board. In some embodiments, the audio module comprises a memory module and processor. In some embodiments, the audio module is configured to play the one or more sounds using a speaker. In some embodiments, the speaker is disposed within the back cover. In some embodiments, the back cover comprises one or more speaker holes. In some embodiments, at least one speaker hole of the one or more speaker holes is not visible external to the back cover, wherein the speaker hole(s) that are not visible is configured to provide diaphragmatic resonance of the one or more sounds. In some embodiments, each page button corresponds to a touch sensor. In some embodiments, the one or more sounds are audio mastered. In some embodiments, the grid array comprises an “m”×“n” format, wherein “m” represents a predetermined number of rows, and “n” represents a predetermined number of columns. In some embodiments, the grid array comprises a square grid array, wherein the number of rows is equal to the number of columns. In some embodiments, the grid array comprises a rectangular grid array, wherein the number of rows is different from the number of columns. In some embodiments, the grid array comprises from about 5 rows to about 20 rows, and from about 4 columns to about 16 columns. In some embodiments, the plurality of paper pages comprises at least about 5 paper pages. In some embodiments, the plurality of paper pages comprises at least about 10 paper pages. In some embodiments, the plurality of paper pages comprises at least about 20 paper pages. In some embodiments, the interactive paper-based book further comprises at least about 500, 1000, 10000, or 50000 images.

Disclosed herein, in some embodiments, is an interactive poster comprising: a back cover comprising a plurality of touch sensors and an audio module; and one or more images on an opposite side of the back cover, wherein each image is associated with a plurality of words, wherein each image is aligned with a corresponding touch sensor of the plurality of touch sensors on the back cover, wherein the audio module is configured to play one or more sounds associated with an image of the one or more images when the user touches the image.

Disclosed herein, in some embodiments, is a method for providing an interactive environment, the method comprising: a) providing an interactive paper-based book comprising: a back cover comprising a plurality of touch sensors and an audio module; and a plurality of paper pages that are stacked together on top of each other, wherein each of the pages comprises a grid array of images associated with a plurality of words, wherein the grid array of images on the plurality of pages are aligned with the plurality of touch sensors on the back cover, wherein each of the pages and a set of audio files for each page are configured to be activated using a page button corresponding to the respective page, wherein the page buttons are located on one or more portions of the book, and wherein the audio module is configured to play one or more sounds associated with an image on an activated page when the user touches the image on the activated page; b) activating a page and corresponding set of audio files; c) receiving an input for one or more sounds associated with an image on the activated page; and d) playing one or more sounds associated with the image.

Disclosed herein, in some embodiments, is a method for providing an interactive game environment, the method comprising: a) providing an interactive paper-based book comprising: a back cover comprising a plurality of touch sensors and an audio module; and a plurality of paper pages that are stacked together on top of each other, wherein each of the pages comprises a grid array of images associated with a plurality of words, wherein the grid array of images on the plurality of pages are aligned with the plurality of touch sensors on the back cover, wherein each of the pages and a set of audio files for each page are configured to be activated using a page button corresponding to the respective page, wherein the page buttons are located on one or more portions of the book, and wherein the audio module is configured to play one or more sounds associated with an image on an activated page when the user touches the image on the activated page; b) activating a page and corresponding set of audio files; c) playing one or more sounds associated with a first randomly selected image from the activated page; d) receiving input to the touch sensor aligned with the first randomly selected image; and e) playing one or more sounds associated with a second randomly selected image from the activated page.

In some embodiments, for any method disclosed herein, the grid array comprises an “m”×“n” format, wherein “m” represents a predetermined number of rows, and “n” represents a predetermined number of columns. In some embodiments, for any method disclosed herein, the grid array comprises a square grid array, wherein the number of rows is equal to the number of columns. In some embodiments, for any method disclosed herein, the grid array comprises a rectangular grid array, wherein the number of rows is different from the number of columns. In some embodiments, for any method disclosed herein, the grid array comprises from about 5 rows to about 20 rows, and from about 4 columns to about 16 columns. In some embodiments, for any method disclosed herein, the plurality of paper pages comprises at least about 5 paper pages. In some embodiments, for any method disclosed herein, the plurality of paper pages comprises at least about 10 paper pages. In some embodiments, for any method disclosed herein, the plurality of paper pages comprises at least about 20 paper pages. In some embodiments, for any method disclosed herein, further comprising at least about 500, 1000, 10000, or 50000 images.

These and other embodiments are described in further detail in the following description related to the appended drawing figures.

### BRIEF DESCRIPTION OF THE DRAWINGS

Specific embodiments of the disclosed devices, delivery systems, or methods will now be described with reference to the drawings. Nothing in this detailed description is intended to imply that any particular component, feature, or step is essential to the invention.

FIG. 1 shows an exemplary depiction of an interactive book described herein.

FIG. 2A shows an exemplary depiction of a page of an interactive book described herein with a plurality of images arranged in a grid format.

FIG. 2B shows an example of the grid format on a page of an interactive book described herein.

FIG. 2C shows a plurality of images that may be printed onto a page of an interactive book described herein.

FIG. 3 shows a page an interactive book described herein wherein interactive elements are located on the perimeter of the page.

FIG. 4 shows a schematic side view of an interactive book and the configuration of the pages and base therein.

FIGS. 5A-B show exemplary pages of an interactive book described herein wherein the page number activators are located on the top of each page.

FIGS. 6A-B show exemplary pages of an interactive book described herein wherein the page number activators are built-in to the frame of the book at the top.

FIG. 7 shows a side perspective view of an interactive book described herein.

FIG. 8 shows an exemplary depiction of sound emanating from an interactive book described herein.

FIG. 9 shows an exemplary depiction of ways to use an interactive book described herein.

FIG. 10A shows an exemplary categorization of files corresponding to the pages of an interactive book described herein.

FIG. 10B shows exemplary sound files for an interactive book described herein.

FIG. 11A shows an exemplary first page number being selected of an interactive book described herein.

FIG. 11B shows exemplary intro sound files corresponding to page 1 of FIG. 11A.

FIG. 12A shows a plurality of images that may be printed onto a page of an interactive book described herein.

FIG. 12B shows exemplary sound files corresponding to an image of FIG. 12A

FIG. 12C shows a select number of images from the plurality of images of FIG. 12A.

FIG. 12D shows an exemplary row of a plurality of images of FIG. 12A organized in grid format.

FIG. 12E shows exemplary sound files corresponding to an image of FIG. 12D.

FIG. 12F shows exemplary sound files corresponding to an image of FIG. 12D.

FIG. 13 shows exemplary universal buttons as part of an interactive book described herein.

FIG. 14 shows an exemplary depiction of an interactive poster described herein.

FIG. 15 shows an exemplary depiction of the back side of the interactive poster from FIG. 14.

FIG. 16 provides an exemplary flow chart of at least some of the operative components of an interactive book described herein.

FIG. 17 shows an exemplary image of some of the operative components from FIG. 16.

FIG. 18 shows an exemplary image of some of the operative components from FIG. 16.

FIG. 19 shows an exemplary image of an audio module comprising a printed circuit board.

FIG. 20 shows an exemplary image of a speaker described herein.

FIGS. 21A-B show an exemplary depiction of a representative location of a speaker within base of an interactive book described herein.

FIG. 22 shows an exemplary configuration of components of an interactive book described herein.

FIG. 23 shows an exemplary image of touch sensor substrate.

FIG. 24 shows an exemplary flow chart of activating an image sound on an interactive book described herein.

FIG. 25 shows an exemplary flow chart of playing a game on an interactive book described herein.

FIG. 26A-H provides an exemplary flow chart of the programing for an interactive book described herein, and corresponding expanded views of the flow chart.

FIG. 27 provides an exemplary depiction of a capacitive touch grid used for an interactive book described herein.

FIG. 28 provides exemplary variables used with the programming and as shown with FIG. 26A-H.

FIG. 29 provides an exemplary an exemplary depiction of a spread of an interactive book described herein with a plurality of images arranged in a grid format.

FIG. 30 shows an example of the grid format on a page of a spread of an interactive book described herein.

### DETAILED DESCRIPTION

Specific embodiments of the disclosed device and method of use will now be described with reference to the drawings. Nothing in this detailed description is intended to imply that any particular component, feature, or step is essential to the invention.

Devices and methods as disclosed herein provide an interactive book configured to enhance a user's vocabulary. In some embodiments, the interactive book is configured to enhance other knowledge areas for a user such as enhancing the pronunciation of words, or learning topics such as math, science, music, geography, history and so on. In some embodiments, the interactive book encompasses the scope of the STEAM education. In some embodiments, an interactive paper-based book comprises a back cover comprising a plurality of touch sensors and an audio module and a plurality of paper pages that are stacked together on top of each other. In some embodiments, each of the pages comprises a grid array of images associated with a plurality of words. In some embodiments, the grid array of images on the plurality of pages are aligned with the plurality of touch sensors on the back cover. In some embodiments, each of the pages and a set of audio files for each page are configured to be activated using a page button corresponding to the respective page. In some embodiments, the page buttons are located on one or more portions of the book. In some embodiments, the audio module is configured to play one or more sounds associated with an image on an activated page when the user touches the image on the activated page.

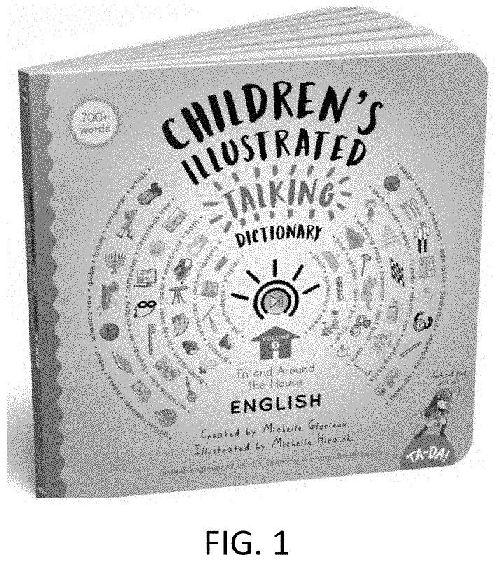

FIG. 1 provides an exemplary depiction of an interactive book in accordance with some embodiments. The book may be manufactured in any shape, size, or dimension. In some embodiments, the book may be in a large format of 34 cm by 34 cm, wherein a length of the book is 34 cm and a width of the book is 34 cm. In some embodiments, the book comprises a length of at least about 10 cm and width of at least about 10 cm. In some embodiments, the book comprises a length from about 10 cm to about 70 cm and a width from about 10 cm to about 70 cm. The book may comprise a plurality of pages. The pages may be made of paper. In some embodiments, the pages may be made of a non-paper material such as canvas, linen, leather, plastic, and the like. One or more portions of the book (e.g. backing) may be made from paper or cardboard, or any other type of appropriate backing material. A page of the book may be provided in any thickness, for example ranging from about 0.1 mm to about 0.5 mm. In some cases, a page of the book may be less than about 0.1 mm or greater than about 0.5 mm. The book may be formed having any weight that is suitable for a child or an adult to lift, carry or transport around. In some embodiments, the interactive book comprises at least 5 pages. In some embodiments, the interactive book comprises at least 10 pages. In some embodiments, the interactive book comprises at least 20 pages. In some embodiments, the interactive book comprises from about 5 pages to about 25 pages.

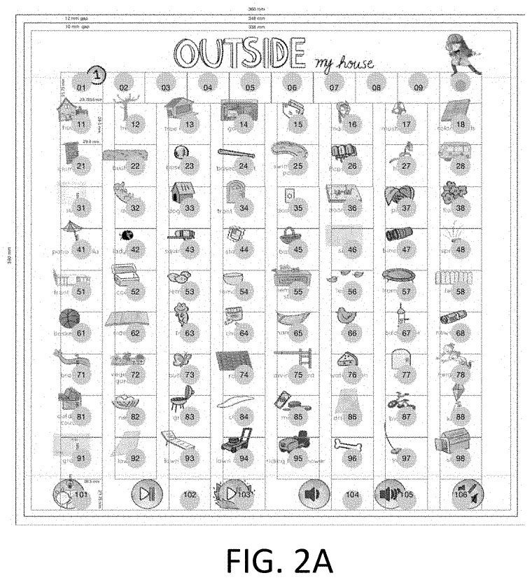

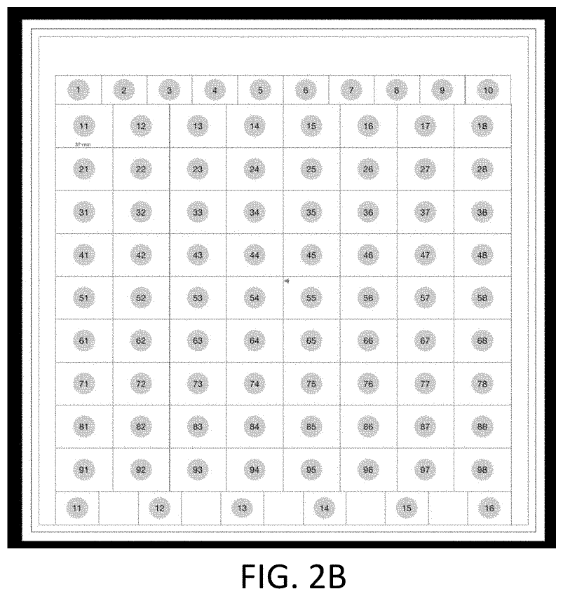

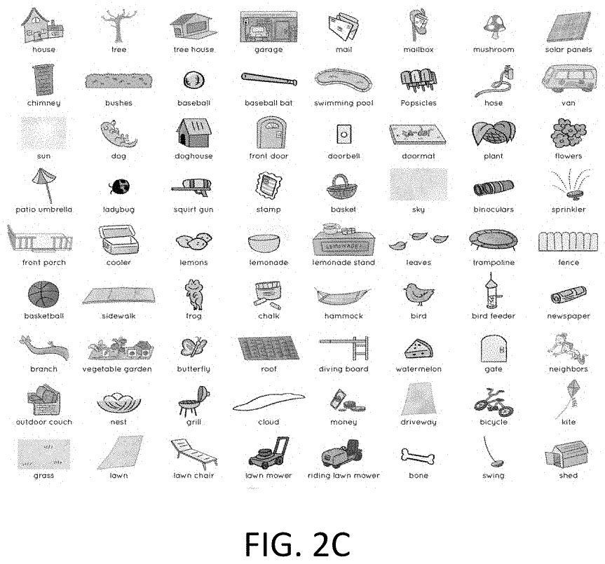

FIG. 2A illustrates an exemplary page of the interactive book. A plurality of images may be printed on one or more pages of the book. The images may provide a rich visual experience. Each image may correspond to an interactive element, that allows a user/reader to interact with the book. The images may be in color. In some alternative embodiments, one or more of the images are not in color. In some embodiments, the images may be printed having a plurality of colors that are designed to provide a visual impact to the reader, and to promote reader interest and interactivity with the book.

In some embodiments, the images on the page of the interactive book may be provided in an m×n grid format, wherein “m” represents the number of rows in the grid format, and “n” represents the number of columns in the grid format. The grid format may comprise one or more rows and columns. A grid format as described herein may be an array or a matrix comprising a plurality of interactive elements. In some embodiments, a plurality of images provided on a page correlate to the plurality of interactive elements. In some embodiments, “m” and “n” of the grid format may be any integer, and may be the same or different. In some embodiments, the images may be provided in a grid format comprising 9 rows and 8 columns. In some embodiments, the grid format for any page of the interactive book comprises from about 1 row to about 20 rows and from about 1 column to about 20 columns.

FIG. 2B illustrates an example of the grid format on a page of the interactive book. The grid may comprise a plurality of locators provided in an m×n grid format. In some embodiments, each locator is identified by a specific row number and column number (i.e. a specific “m” and “n”). The grid format can enable scalability of the book, so as to include a large number of interactive or touch elements. The locators may be spaced apart from one another by a fixed distance or by variable distances. The locators may be formed having any shape and/or size. In some embodiments, the locators may have a circular shape, for example as shown in FIG. 2B. Each locator may correspond to a preset location for a selected image and/or interactive element. As described herein, in some embodiments, an interactive element comprises a touch sensor. The locators may be flush with the plane of the page. In some embodiments, each locator may be slightly recessed within the page. In other embodiments, each locator may extrude slightly above the page. In some cases, recessing or extruding the locator can provide a sense of depth to the images/interactive elements, and to distinguish those images/interactive elements from the background on the rest of the page. It should be appreciated that the locators need not be recessed, for example when conductive ink is used to create the touch buttons (which can be activated by touch as opposed to a pressing force).

FIG. 2C illustrates a plurality of exemplary images that may printed onto a page of the interactive book. The number of images may range from 10s, 100s, 1000s, and tens of 1000s of images. In some embodiments, a page may contain from about 1 image to about 50,000 images. In some embodiments, a page may contain from about 10 images to about 500 images. In some embodiments, a page may contain from about 50 images to about 500 images. In some embodiments, a page may contain from about 50 images to about 1,000 images. In some embodiments, a page may contain from about 50 images to about 10,000 images. In some embodiments, printing the images (FIG. 2C) onto the corresponding locators (FIG. 2B) produces a page of the interactive book, for example as shown in FIG. 2A.

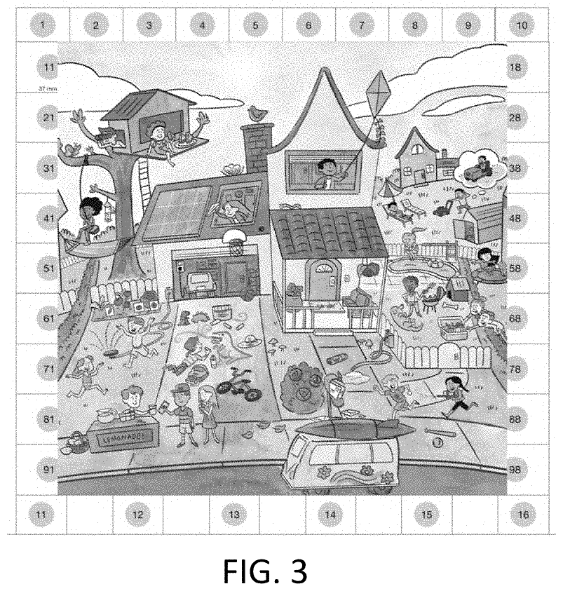

In some embodiments, the plurality of locators are not provided in grid format. In some embodiments, the locators may be placed along a perimeter of the page around a large picture, for example as shown in FIG. 3. The locators may surround the picture, similar to a frame for the picture. Each locator may correspond to a preset location for 1) an image or section of the large picture, and/or 2) an interactive element. For example, the locators on the right side of the picture may be associated with images or elements near the right portion of the picture, and locators on the bottom side of the picture may be associated with images or elements near the bottom portion of the picture. It should be appreciated that the locators may be placed in any suitable configuration, and need not be limited to a grid format or a frame-like format.

In some embodiments, the interactive book may be a “talking” picture dictionary. The “talking” picture dictionary can provide a vocabulary immersion program. Children can use the “talking” picture dictionary to learn how to pronounce a variety of different new words. In some embodiments, the learning process is enhanced by a sound speaker within the book emitting an audio recording of each word when a child presses on the image of the word on the page. The image may be aligned with a touch sensor on the base of the book as described herein. In some embodiments, the touch sensor may be a pressure sensitive button, which is activated when the child presses on the image on the page and transmits a touch force to the underlying pressure sensitive button. In other embodiments, the touch sensor may be incorporated into the page as a conductive ink button, which can be activated by merely touching the button (as opposed to pressing on the button). The audio recording may include a human native speaker pronunciation of each word. In some embodiments, the audio recordings may include a variety of correct pronunciations of common words that are encountered in everyday conversations or life. In some embodiments, the images and sounds can be customized to help trigger recognition (regardless of the user's native language) and prepare the user's brain for optimal word absorption in the target language of the book.

In some alternative embodiments, the sound speaker need not be within the book, but may be adjacent to the book. For example, the sound speaker may be provided by a smart speaker that is used at home.

The book may comprise a memory module for storing audio recordings of a plurality of words (as described herein). The number of words and audio recordings may range from 10s, 100s, 1000s, and tens of 1000s of words. In some embodiments, the number of words and audio recordings stored on the memory module is from about 1 to about 100,000. In some embodiments, the number of words and audio recordings stored on the memory module is from about 1 to about 1,000,000. In some embodiments, the number of words and audio recordings stored on the memory module is from about 10 to about 500. In some embodiments, the number of words and audio recordings stored on the memory module is from about 100 to about 1,000. In some embodiments, the number of words and audio recordings stored on the memory module is from about 100 to about 10,000. In some embodiments, the number of words and audio recordings stored on the memory module is from about 1,000 to about 100,000. In some embodiments, the number of words and audio recordings stored on the memory module is from about 10,000 to about 1000,000. Each word may have a sound pronunciation of the word in one or more languages. The one or more languages may include a child's native language, as well as one or more foreign languages.

In some embodiments, each word may include a plurality of different voice recordings. For example, each time an image of a word on the page is touched by a user, a different audio recording of the word may be emitted. The different audio recordings may include one or more human speakers saying each word in a different manner or tone (e.g. quickly, slowly, carefully, in a humorous manner, in an exaggerated manner, syllabically, etc.). The audio recordings may be in a same language or in different languages. The audio recordings may be emitted in order or randomized. In some embodiments, every time a user's finger touches an image on the paper, randomization can allow for up to a number of different, human native speakers pronouncing the same word (emitted via the audio recordings), thus providing a rich, aural tool for language learning.

In some embodiments, the interactive elements can allow different pages of the book to be activated. For example, referring to FIG. 2B, the top row of the grid illustrates a row of numbers ranging from 01 through 10. These numbers may correspond to page numbers. Each of the page numbers may be provided as a page button. The page buttons can enable scalability of the book, such that different pages of the book (and the audio recordings for different pages of the book) can be activated at different times. The page buttons can also help to reduce or maintain the form factor and/or size of the book, such that multiple pages can be stacked on top of another, and different pages can be activated for interactivity at different times, depending on which page button is pressed.

For example, when a user presses page button 01, the first page (page 1) of the book may activated. The activation of a page may be indicated by light and/or audio signals. For example, page button 01 may light up when pressed, to show that page 1 has been activated. In some cases, an audio signal saying “page 1” may be emitted when page 1 has been activated. In some embodiments, different colored lights may be associated with the different page buttons. For example, page button 01 may have a green light when activated, page button 02 may have a blue light when activated, page button 03 may have a pink light when activated, and so forth. The different colored lights can allow activation of different pages to be distinguished from one another. In some embodiments, visual signals are provided using lights, screens, electrochromic film, or combinations thereof.

Page 1 of the book may comprise a plurality of different images associated with different words (e.g., as correlated with locators 11 through 98 in FIG. 2A). When page 1 is active, an audio recording of a word will be emitted by the book when a user presses the corresponding image of the word. For example, image 13 depicts a tree house. When a user presses on image 13 on the page, a first audio recording of the word “tree house” spoken in a first manner (e.g. slowly) will be emitted. When the user presses on image 13 on the same page a second time, a second audio recording of the word “tree house” spoken in a second manner (e.g. quickly) will be emitted. And when the user presses on image 13 on the same page a third time, a third audio recording of the word “tree house” spoken in a third manner (e.g. syllabically) will be emitted. Accordingly, the user can learn different variations of a same word spoken in different manners, which can help to enhance the learning process, as well as the ability to recognize a same word spoken in various contexts/manners.

In some embodiments, the images may be placed in a logical fashion. For example, the word “tree house” is made up of two words: “tree” and “house.” Image 11 on page 1 (FIG. 2A) shows a house, and image 12 on page 1 shows a tree. These two words/images precede image 13 (tree house). The user may learn the words in a forward or backward sequence. For example, the user may start with images 11 (house) and 12 (tree), and subsequently realize that image 13 (tree house) is a combination of the words in images 11 and 12. Alternatively, the user may start with image 13 (tree house), and subsequently realize that it is a combination of two words image 12 (tree) and 11 (house). Allowing the user to connect between different words, images and sounds (audio recordings of those words) can help to reinforce learning and memory retention process.

When the user has completed learning the words on page 1 or wishes to proceed to another page (e.g. page 2), the user may flip over page 1. On the next page, the user can press page button 02 in order to activate the second page. Page 2 of the book may comprise another set of different images associated with another different set of words (e.g. 211 through 298) (not shown). The user may proceed to interact with the book by pressing the images on the page 2 and learn additional new words. In the example of FIG. 2A, the book may include a first set of pages (e.g. pages 1 through 5) that are associated with things outside the house, and a second set of pages (e.g. (pages 6 through 10) that are associated with things inside the house. The various images and sounds can help to keep the user interested and engaged, as the user explores the different pages of the book and learn new words. The interactive book can comprise paper and electronics that allow children to simply touch the images on the paper with their finger, and the words can come to life with the sound speaker emitting ambient sounds and pronunciations by human native speakers.

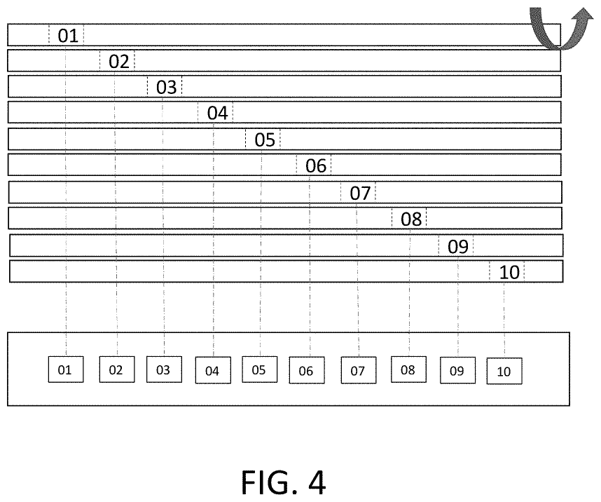

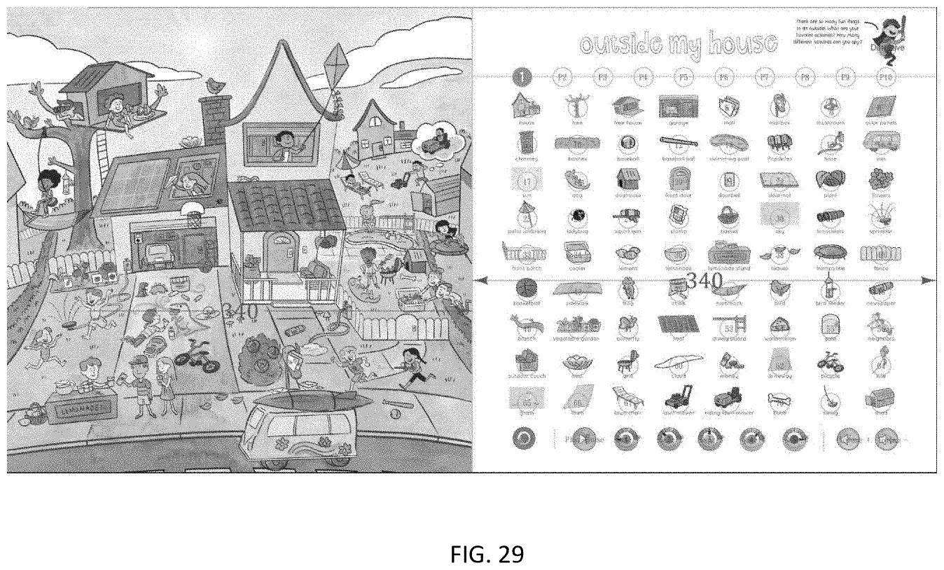

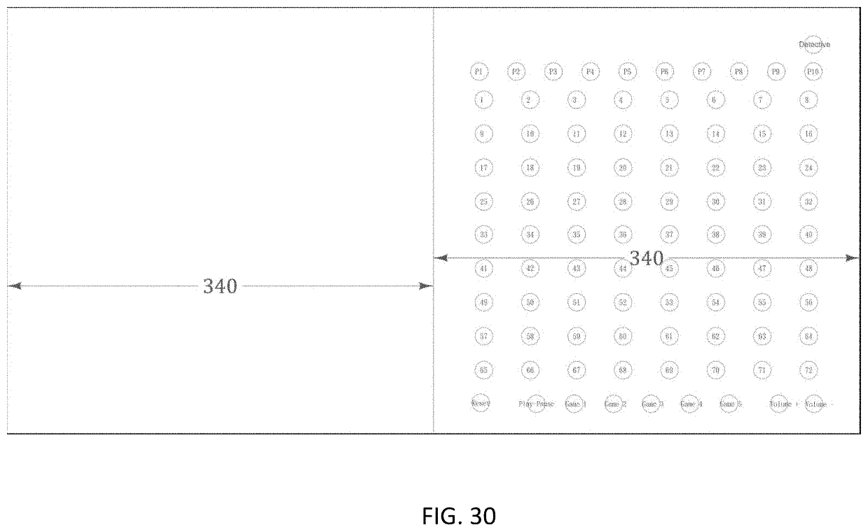

FIG. 4 illustrates a schematic side view of an interactive book, in accordance with some embodiments. The book may comprise any number of pages. The book may comprise any number of spreads. A spread may comprise one or more pages. For example, a spread may comprise two pages that are opened side-by-side (one page on the left, and another page on the right side of the book). FIGS. 29-30 provide exemplary spreads of images on a spread of a book with pages side by side (FIG. 29), and a locator grid one side of the page (FIG. 30). In some embodiments, the interactive book may comprise ten pages ranging from page 1 through page 10. It should be noted that the dimensions are not to scale, and that the drawing is merely illustrative. The pages may be stacked together and bound together as a book. Each page may have a page button associated with the page, and that can be used to activate the audio recordings of the words on that page. For example, page button 01 (or “1”, or “P1”, etc) can be used to activate the audio recordings of a first set of words/images on page 1, page button 02 (or “2”, or “P2”, etc) can be used to activate the audio recordings of a second set of words/images on page 2, and so forth. The audio recordings for each page may be stored in an audio module located in a base. The audio recordings may come prestored in the audio module. The audio recordings need not be downloaded using a computer or CD to the audio module.

The base may be, for example a back cover of the book. The audio module may comprise a plurality of touch-activated audio recordings. For example, when a user presses the page button 01, all of the audio recordings for the words on page 1 become active. The audio recordings for the words on the remaining pages (2 through 10) do not become active, unless the page buttons for those pages are pressed. The page buttons may be configured to be activated one at a time. The audio recordings are configured to be active one page at a time. When page 1 is active, pressing any image on page 1 will cause an audio recording of the word associated with that image to be emitted, for example via a sound speaker located at the base.

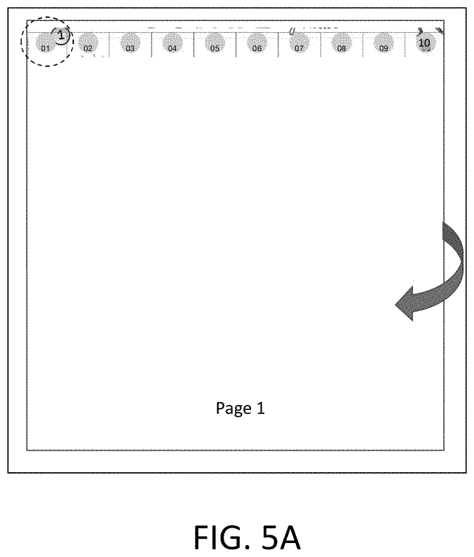

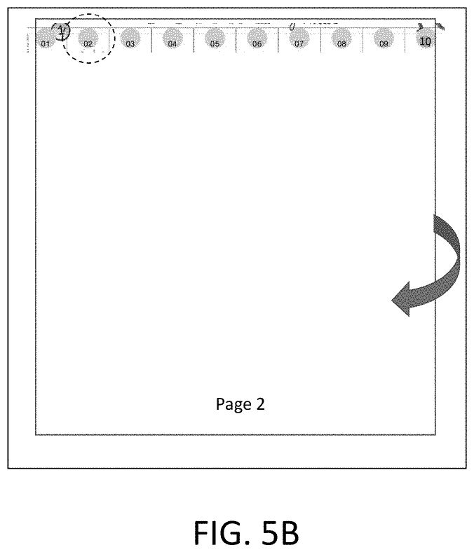

FIGS. 5A and 5B illustrate activation of the pages in accordance with one embodiment. In this example, the page buttons ranging from 01 through 10 may be located near the top of each and every page. As shown in FIG. 5A, the pressing of page button 01 causes page 1 to be active. When the user has completed interacting with the images on page 1, the user may then flip over to page 2 and activate the page by pressing page button 02 on the top of page 2 (FIG. 5B). The user may proceed sequentially from pages 1 through 10 sequentially. In some embodiments, the user may skip between pages. For example, after completing page 1, the user may wish to turn to page 5. When the user has flipped to page 5, the user may activate the page by pressing page button 05 on that that page. Activation of a page, as previously described, activates the audio recordings of the words on that page. When a user presses on an image on an active page, one or more audio recordings of the word associated with that image will be emitted to the user.

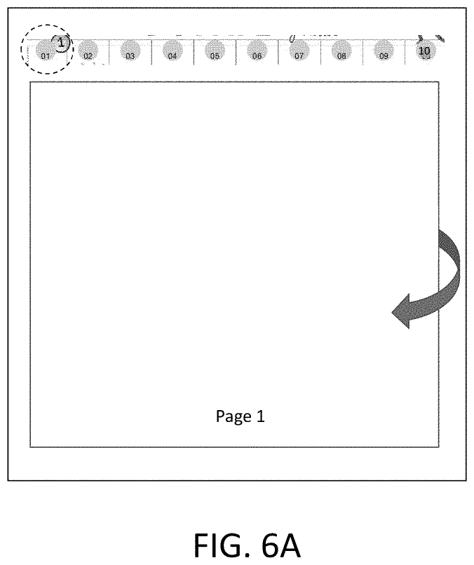

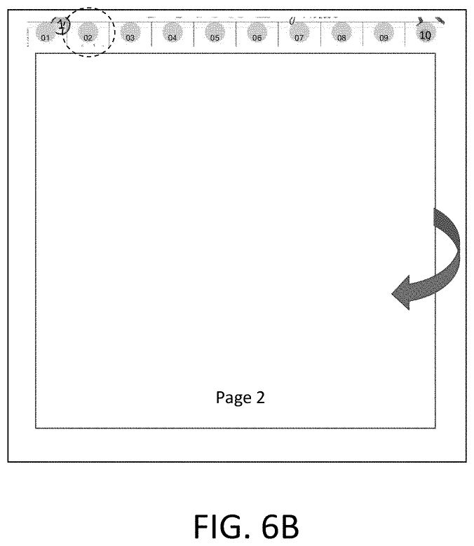

FIGS. 6A and 6B illustrate activation of the pages in accordance with another embodiment. In this other example, the page buttons ranging from 01 through 10 need not be located on the pages. Instead, the page buttons may be built into a frame of the book. The frame of the book can be customized to fit the size of the pages. As shown in FIG. 6A, the page buttons 01 through 10 may be located at a top portion of the book frame. The top portion of the book frame is visible to the user, and is not obscured by the pages. When the user presses page button 01 on the frame, the audio recordings of the words on page 1 of the book will be activated. When the user has completed page 1 and flips to the next, the audio recordings of the words on page 2 of the book will be activated when the user presses page button 02 on the frame (see FIG. 6B).

### Operative Components

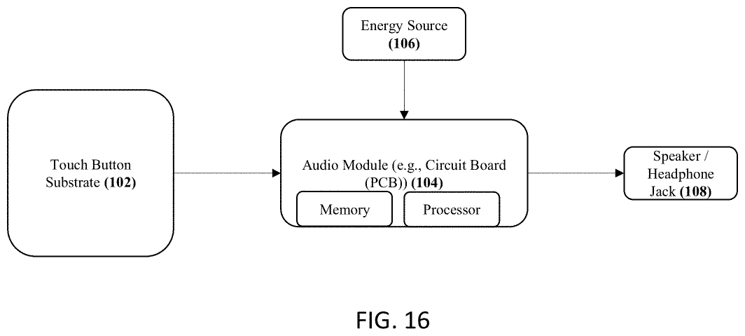

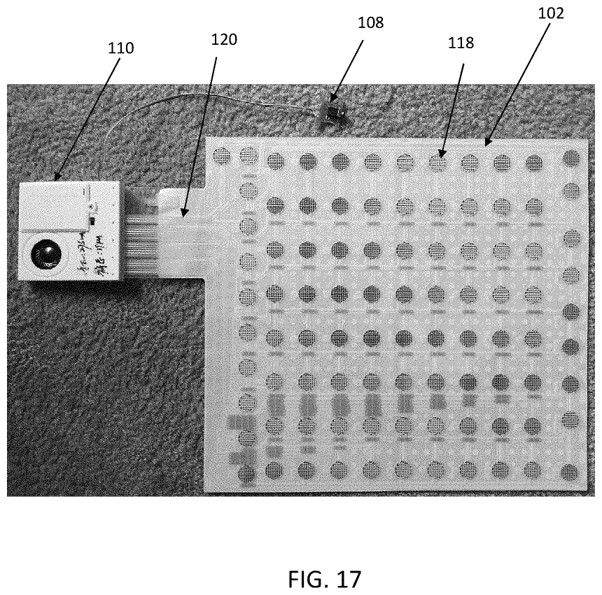

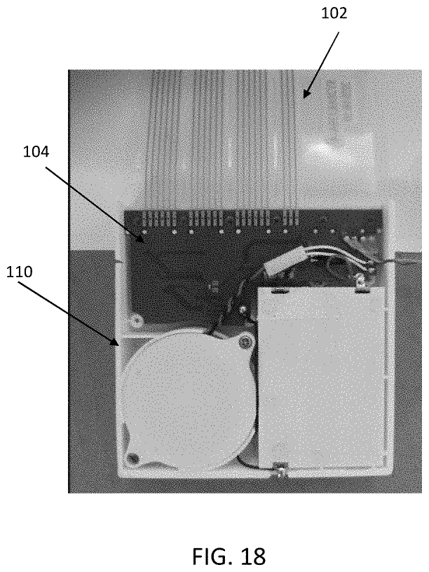

FIGS. 16-17 provide an exemplary depiction of at least some of the operative components of an interactive book described herein. FIG. 16 depicts a touch button substrate 102 (or membrane), wherein one or more touch sensors 118 are in electrical communication with an audio module 104. In some embodiments, an energy source 106 supplies energy to the audio module 104, which comprises a memory module and a processor module. In some embodiments, the audio module provides signals to an audio output, such as one or more speakers 108 or a headphone jack 108. FIGS. 17-18 provides an exemplary image of the aforementioned operative components assembled together for integration with an interactive book described herein, wherein the audio module and energy source (e.g., batteries) are disposed within an audio module compartment 110 (FIG. 18). In some embodiments, the audio module comprises a small enclosure. In some embodiments, other interactive operative elements may be included with the interactive book. In some embodiments, the interactive book may comprise an on/off button.

In some embodiments, a system module is provided which comprises the audio module and other modules, such as a visual module, and a computing module. In some embodiments, the system module is configured to receive input (e.g., via the touch sensors, processing instructions from a given module) and output corresponding video and audio signals. In some embodiments, the system module may be configured to be in communication with an external computing device (e.g., computer, smart device). In some embodiments, the system module may be configured to receive updated sounds and/or visual outputs, and/or an updated software, via communication from an external computing device. In some embodiments, the system module comprises a microphone. In some embodiments, the system module is configured to receive audio from a user (e.g., a user speaking which may be captured by a microphone). In some embodiments, the system module is configured to provide feedback, such as provide instructions, output audio and/or video signals, or combinations thereof, in response to received audio input from a user (such as a user speaking).

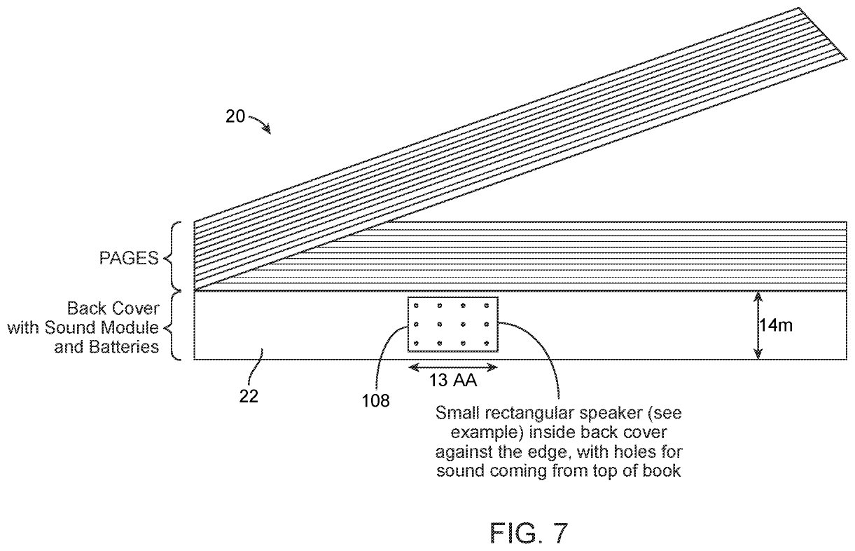

FIG. 7 illustrates a perspective section view of an interactive book, in accordance with some embodiments, wherein the book may include a plurality of pages 20 stacked together. The pages 20 may include the images and interactive elements as describe elsewhere herein. The pages may be supported by a base 22. As described herein, the base 22 may be a back cover of the book. In some embodiments, the base may include the audio module (sound module) and the energy source (e.g. batteries) powering the audio module to play audio recordings upon activation of the pressed images (interactive elements).

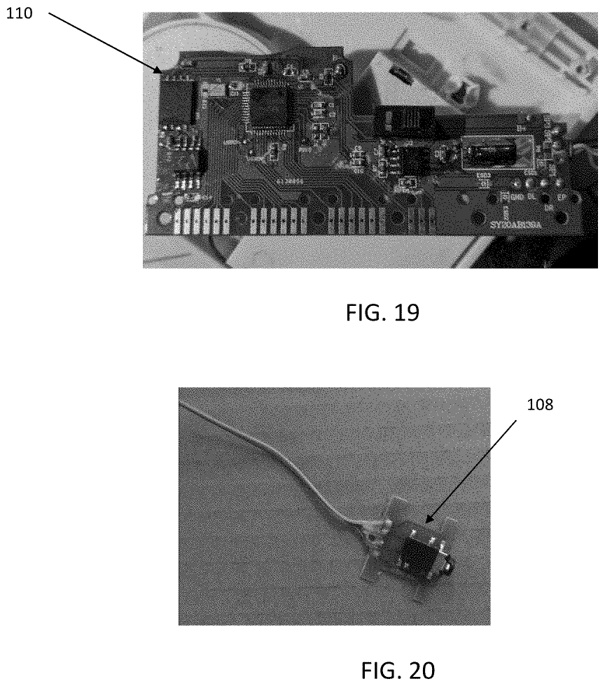

As described herein, in some embodiments, the audio module comprises a printed circuit board (PCB). FIGS. 18-19 provide an exemplary depiction of a PCB. In some embodiments, the PCB is incorporated into the interactive book described herein (e.g., disposed within the base). In some embodiments, the PCB is a small form factor printed circuit board (PCB). In some embodiments, the PCB comprises a memory module, a processor module, and one or more integrated circuits (ICs) providing electrical communication between the memory module, the processor module, and/or one or more touch sensors described herein. In some embodiments, the PCB comprises a codec (e.g., ggg/wave). In some embodiments, the memory module comprises a memory chip (or other built-in storage device). In some embodiments, the memory chip(s) (or built-in storage) provides from about 50 MB to about 8 GB of storage space. In some embodiments, the PCB has dimensions of 50 mm×20 mm×4 mm. In some embodiments, the audio module may include a flexible circuit board, or a ribbon-like flexible printed circuit sheet (such as a flex connector) connecting between different parts of the book.

In some embodiments, the energy source comprises one or more batteries. In some embodiments, the energy source comprises a coin battery disposed on the PCB. In some embodiments, the energy source comprises a coin battery disposed separate from the PCB. In some embodiments, the energy source comprises one or more alkaline batteries. In some embodiments, the energy source comprises one or more “AA” batteries, “AAA” batteries, “C” batteries, “D” batteries, and the like. In some embodiments, the batteries are configured to be recharged within or external to the interactive book. In some embodiments, the batteries are recharged via solar power. In some embodiments, the back cover may comprise a solar panel for recharging the batteries. In some embodiments, the batteries are recharged via connection to a power outlet. In some embodiments, the energy source receives power from a power outlet.

In some embodiments an audio output (e.g., speaker, headphone jack) is in communication with the PCB. In some embodiments, the PCB comprises a small speaker. In some embodiments, the headphone jack is located on the base separated from the PCB. In some embodiments, the speaker is located external to the PCB and in communication with the PCB. FIGS. 18 and 20 provides an exemplary depiction of a speaker 108 with wiring connected to the PCB. In some embodiments, the speaker is about 29 mm (e.g., a 29 mm loud speaker). In some embodiments, the speaker is at most 50 mm in diameter. In some embodiments, the speaker is at most 100 mm in diameter.

In some embodiments, the battery, audio module and speaker are stored in a compartment within the base of the interactive book. In some embodiments, the PCB, audio module and speaker are disposed in different compartments in the audio module compartment 110 that is located within the base (FIG. 18). In some embodiments, the speaker is located external to the audio module compartment 110. As seen in FIG. 22, on some embodiments, the touch sensor substrate is located below the pages of the interactive book, wherein the audio module is located below the touch sensor substrate. In some embodiments, as described herein, the touch sensor substrate will fold over to the audio module so as to enable electrical communication between the touch sensors and audio module.

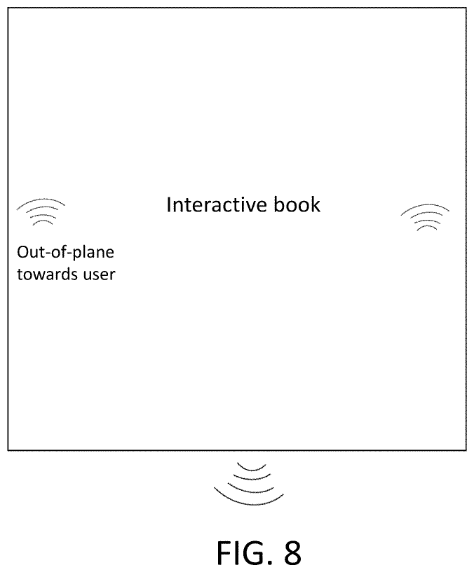

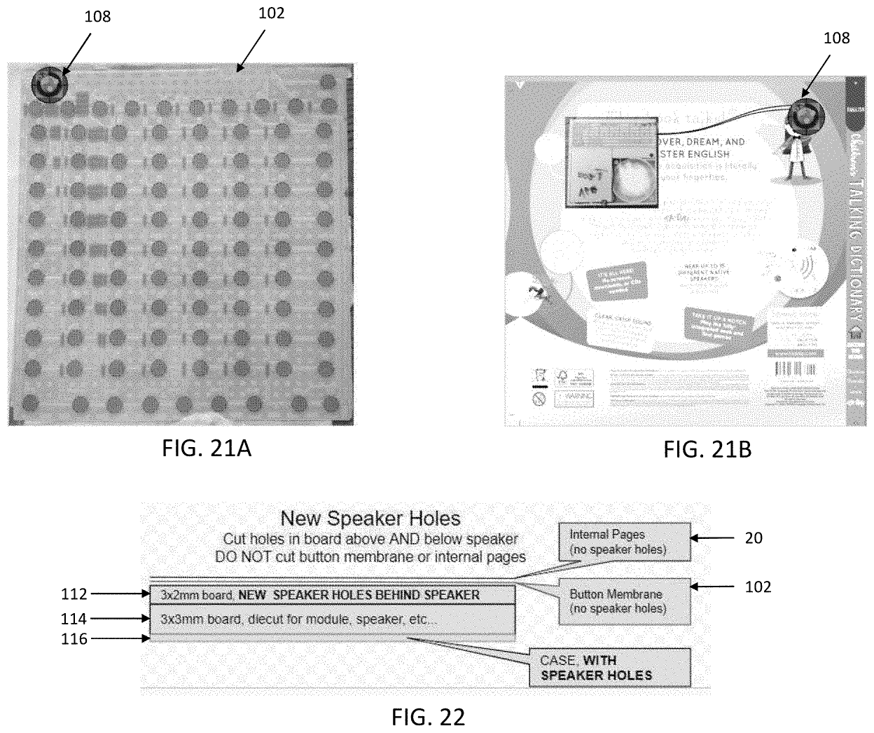

The base may include one or more sound speakers 108 located at an edge or periphery of the base, for example as shown in FIGS. 21A-B or as shown in FIG. 7. As shown in FIGS. 21A-B, the positioning of the speaker is only representative of its location in relation to the interactive book. As described herein, in some embodiments, the speaker is disposed beneath a touch sensor substrate (or membrane) (FIG. 21A), and within a back cover (FIG. 21B) The one or more sound speakers 108 are configured to emit sounds of the audio recordings. In some embodiments, the sounds may be emitted from an edge of the book. In some embodiments, the sounds can be configured to be emitted from a top of the book. In some cases, the sounds can be configured to be emitted from two or more sides of the book. In some examples, a sound speaker may be located on the bottom of a book. The sound speakers can be configured to emit sounds towards the user, for example in-plane (relative to the plane of the book) towards the user, and/or out-of-plane (e.g. normal to the plane of the book) towards the user, as shown in FIG. 8. It should be contemplated that the one or more sound speakers may be placed anywhere around the book in any configuration, in order to enhance audio quality and audibility to the user. FIG. 22 provides an exemplary depiction of a perspective view of an interactive book configuration, wherein speaker holes are provided to enhance audio quality and audibility. As shown in FIG. 22, an interactive book configuration comprises the internal pages 20, with the touch sensor substrate 102 located below the pages 20, followed by a small board 112 below the touch sensor substrate 102 (for support as described herein), followed by a layer 114 comprising the audio module, energy source and speaker, and finally the case 116 of the base at the bottom. In some embodiments, speaker holes are provided below and above (up-side holes) the audio module “layer”, wherein such up-side speaker holes are hidden by the book pages and touch sensor substrate (in some embodiments). In some embodiments, the speaker holes on the case 116 are not hidden. In some embodiments, such configuration of the speaker holes enable the speaker's omnidirectional emanation from the physical platform (base of the book). In some embodiments, the touch sensor substrate 102 and pages 20 covering the up-side speaker holes provides diaphragmatic resonance increasing the perceived fullness of the sound.

In some embodiments, a headphone jack with volume control may be provided at or near the sound speaker. In some embodiments, the audio module may be configured to wirelessly transmit the audio recordings to a headset or earbuds that are worn by the user.

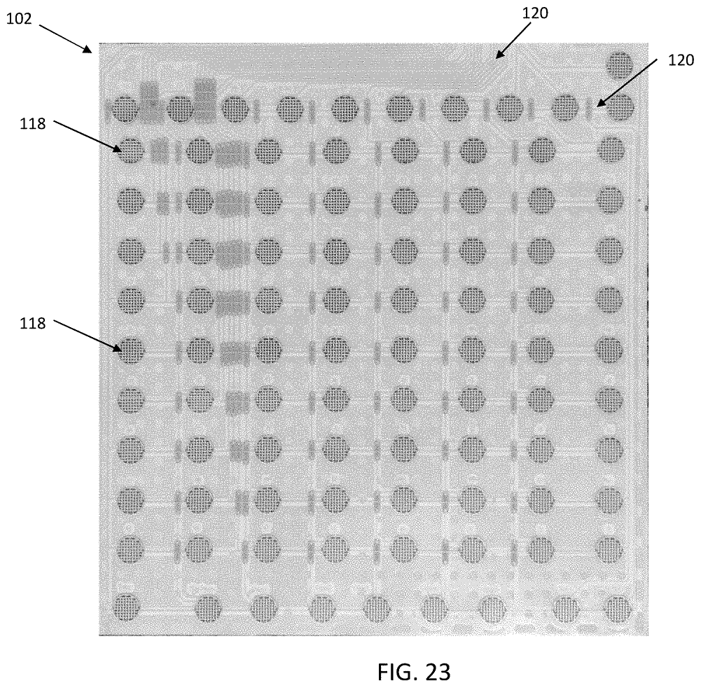

The base of the book may include a plurality of touch sensors. The plurality of touch sensors may be located directly beneath the grid of locators on every page. In some embodiments, the touch sensors are aligned with one or more images printed on corresponding pages in the book (as described herein). The touch sensors 118 may be connected via circuitry 120 as shown in FIGS. 17 and 23, which provides a top view of a touch sensor substrate 102. In some embodiments, the touch sensors 118 are provided on a touch sensor substrate 102 that is disposed within the base (e.g., back cover) of the interactive book. As described herein, each touch sensor 118 may be configured to activate a sound file. As described herein, in some embodiments, the sound file corresponds to an image on a page of the book. The circuitry 120 may be mounted on a printed circuit board or printed wiring board. In some embodiments, the touch sensors 118 may be mounted directly on conductive printed circuitry or formed on a part of the book, such as on the base, using conductive glues or inks. In some embodiments, the touch sensors 118 may comprise capacitive touch elements. The electrical traces (electric circuitry 120) in communication with the touch sensors may be formed using conductive ink, e.g. a silver-based conductive ink printed on a sheet. Other forms of conductive ink can be used, such as a copper-based conductive ink or some other metallic-based conductive ink, or a carbon-based conductive ink. The touch sensors 118 and traces (circuitry 120) may be formed using a printing process, such as screen printing, ink jet printing, flexography or offset printing. The conductive traces 120 (circuitry) can be used for connecting the touch sensors 118 to the audio module 104, such that the appropriate audio recording is played when the corresponding image on a page 20 is touched.

In some embodiments, there are at least about 5, 10, 25, 50, 100, 200, or 500 touch sensors 118 located on a touch sensor substrate 102. In some embodiments, each touch sensor 118 is at most about 10 mm, 15 mm, 25 mm, or 50 mm in diameter. In some embodiments, each touch sensor 118 comprises a substantially flat configuration. In some embodiments, one or more touch sensors 118 are slight slightly recessed into the touch sensor substrate 102. In some embodiments, one or more touch sensors 118 slightly protrude from the touch sensor substrate 102. In some embodiments, each touch sensor 102 is in electrical communication with the audio module 104 (e.g., PCB) via electric circuitry 120. With reference to FIGS. 17 and 22, an assembled configuration of the touch sensor substrate, audio module compartment and speaker may comprise folding over the touch sensor substrate 102 so as to be located above the layer comprising the audio module and energy source. In some embodiments, the folded portion of the touch sensor substrate 102 comprises the circuitry 120 between the touch sensors 118 and audio module 104, thereby establishing electrical communication therebetween. In some embodiments, a board is provided between the touch sensor substrate section comprising the touch sensors and the audio module (e.g., 112 in FIG. 22). In some embodiments, the board provides support for the touch sensors when a user presses the respective touch sensor corresponding to an image.

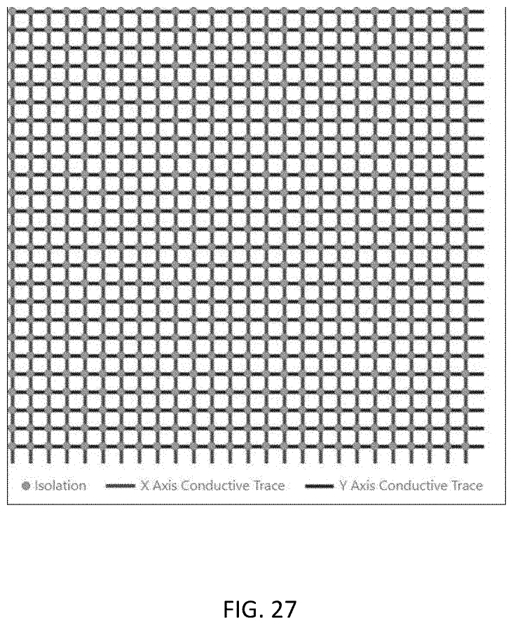

In some embodiments, instead of providing a touch sensor substrate with a plurality of touch sensors, a capacitive touch grid is provided, as shown in FIG. 27, wherein an X-Y coordinate system is used to identify a location that is being touched by a user. In some embodiments, each image on a page of an interactive book described herein will correspond to a specific X-Y coordinate on the capacitive touch grid.

In some embodiments, the base may include a flexible circuit board, or a ribbon-like flexible printed circuit sheet (such as a flex connector) connecting between different parts of the book.

In some embodiments, the touch sensors may be formed into the pages of paper, instead of being located in the base of the book. For example, the touch sensors may be provided on the grid of locators on every page of the book. As described herein, in some embodiments, the touch sensors provided on each page of the book may be a pressure sensitive button, which is activated when a user presses on the image on the page and transmits a touch force to the underlying pressure sensitive button, whereas in other embodiments, the touch sensor may be incorporated into the page as a conductive ink button, which can be activated by merely touching the button (as opposed to pressing on the button). The touch sensors may be electrically connected to the audio module 104 in the base of the book. Such electrical connections may include traces (circuitry) formed using conductive ink that extend across the page, into the spine of the book, and subsequently extending to the audio module at the base of the book.

In some embodiments, the touch sensors, conductive traces, and conductive pads may be printed on sheets of paper, or in the base of the book, using conductive ink. Additionally or optionally, conductive adhesives, conductive paints, conductive foils and the like may be used. These inks may be applied via gravure, screen printing, flexographic, inkjet and other technologies and are well suited for high volume production. Alternatively, one or more of the touch sensors, conductive traces and/or conductive pads may be constructed by any other material that is thin and conductive, such as conductive adhesives, paints or foils.

In some embodiments, other portions of the interactive book may include touch sensitivity. For example, in some embodiments, both pages of each spread in the book, the casing of the book, the spine of the book, or any combination thereof may include touch sensitivity. In some embodiments, such touch sensitivity in other portions of the book may activate audio sounds and/or visual signals.

In some embodiments, the sounds and voices corresponding to the plurality of images in the interactive book are stored in the memory chip(s) (or other built-in storage component) on the audio module (e.g., PCB). In some embodiments, sound files can be transferred to said storage in the audio module. In some embodiments, the stored sounds are processed through audio mastering, which comprises auditioning and perfecting the sound emitted from the interactive book. In some embodiments, the sound is auditioned through the full audio signal path (e.g., audio module, speaker, and/or headphone connected to the headphone jack) so as to provide complete control of the sound emanating from the speakers on the interactive book. Thus, the sound coming from the speakers to a user's ears is exactly as it is heard in a recording studio.

In some embodiments, audio mastering the sound(s) recorded on the audio module comprises first establishing the ideal sound using audio equalization, compression, limiting and other audio-based manipulations (collectively “audio processing”) for the subject matter on a studio equipment. In some embodiments, this ideal sound is used for the digital iterations of the product and as a reference. In some embodiments, the audio processing is then adjusted using either the digital audio interface directly on the audio module, or an analog connection directly to the audio module's loudspeaker, so as to overcome and utilize the physical properties of the platform (e.g., base of the book), and to achieve a likeness to the studio sound. In some embodiments, automatic tonal-matching algorithms and manual adjustments are used to achieve this likeness.

The interactive book/media described herein may be scalable, ranging from small mini-books for children to large format interactive paper-based posters (for both children and adults). The book may be capable of emitting sounds having different vocal/acoustic/auditory characteristics, emotions conveyed in voice recording, tonal quality, expressiveness, accents, words spoken in one or more different languages, for example as described with reference to the talking picture dictionary. In some embodiments, the interactive book may be capable of sensing feedback depending on how often and where a user (e.g. a child) touches the page/paper. The software in the book can customize the next audio signal (sounds) for the child based on feedback received. In some embodiments, the interactive book can provide guidance to the child on which portion of the page to touch, determine/gauge the child's interest level, adjust the level of interactivity depending on the child's interest level, monitor an amount of time that the child spends listening/learning/reading the book, and generate feedback to parents or guardian about the child's learning progress.

### Programming Guide

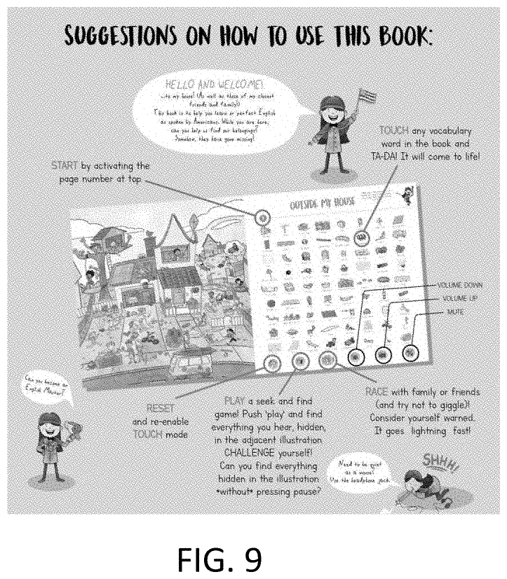

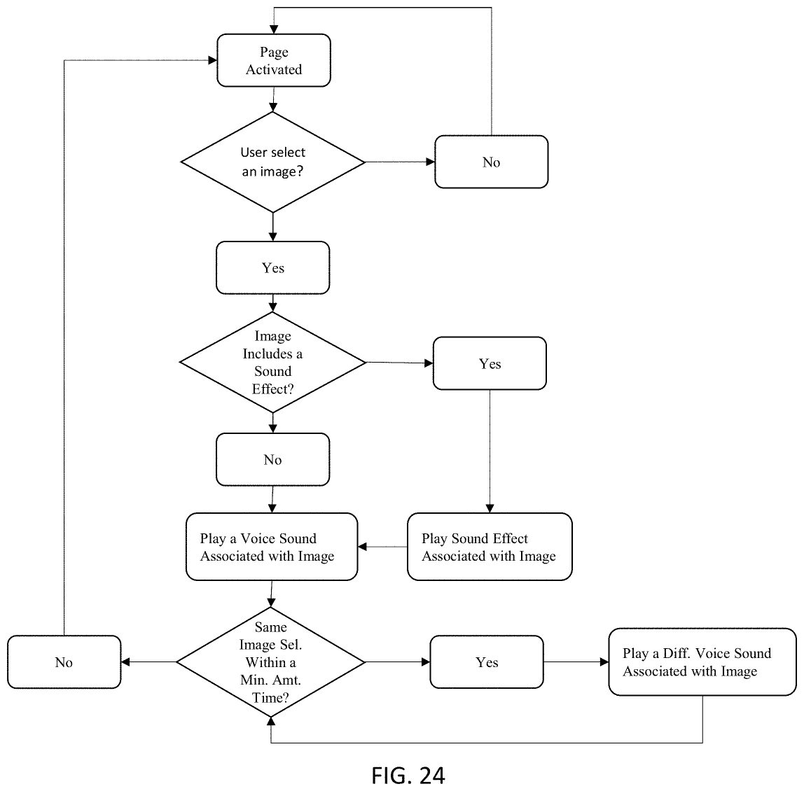

FIG. 9 illustrates a set of suggestions on ways to use the book. A user can start by activating a page number at the top of the book, by pressing a page button. In some embodiments, a page may be activated by via page sensors. In some embodiments, opening a specific page will enable the page to be activated. Once a page is activated, the user can touch any image corresponding to any vocabulary word on the page, which then causes an audio recording of the word to be emitted via a sound speaker in the book. FIG. 24 provides a flow chart of an exemplary operation of the interactive book (as described herein). As described herein, in some embodiments, a selected image plays (emits) a voice recording of the word associated with the selected image. In some embodiments, each image has one or more voice recordings of the same word (for e.g., voice recordings from different speakers). In some embodiments, selecting an image results in a predetermined voice recording being played. In some embodiments, selecting an image results in a randomly selected voice recording being played. In some embodiments, if an image is selected twice consecutively before a predetermined amount of time has elapsed between the two selections, a second voice recording will be played that is different from the first voice recording of the image. In some embodiments, the second voice recording will be predetermined based on a predetermined sequence of voice recordings to be played, or the second voice recording will be randomly selected. In some embodiments, the predetermined amount of time between selecting an image twice for playing multiple voice recordings is at most about 1 second, 3 seconds, 5 seconds, 10 seconds, 30 seconds, or 1 minute.

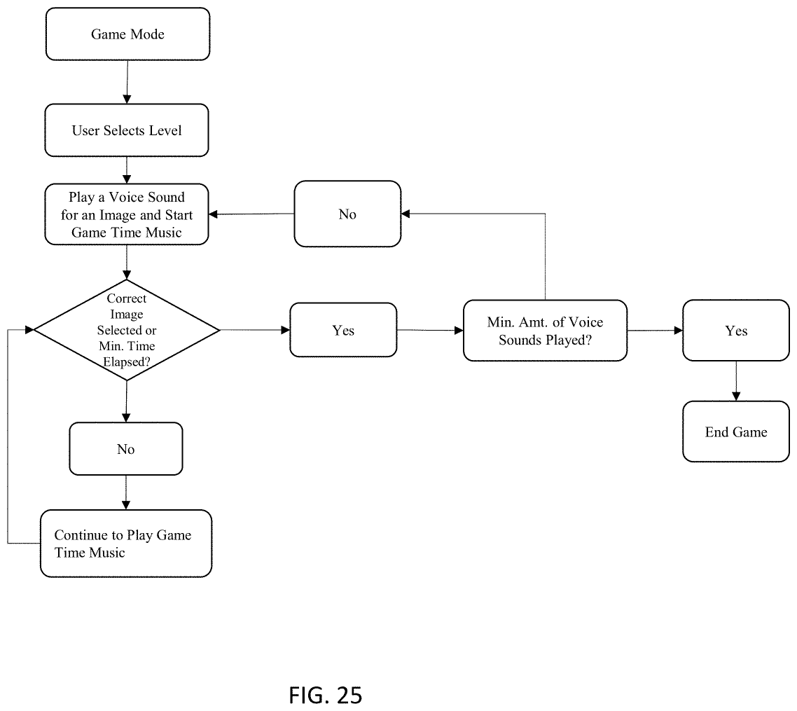

On the bottom of the page is a series of buttons. A first button can be used to reset and re-enable touch mode. In some embodiments, a second button may be the games button, and it can be used to activate a seek and find game. FIG. 25, provides an exemplary flow chart of the operation of the seek and find game. When the user presses the games button, audio recordings of words hidden in the image illustrations will be played, and the objective is for the user to find those words that are hidden in the illustrations. In some embodiments, a predetermined number of audio recordings are played for a given game. In some embodiments, when each audio recording of a word is played (or emitted), a game-time sound commences and will play until 1) the user selects the correct image that corresponds to the audio recording, or a predetermined amount of time has elapsed from when the audio recording of the word was played. In some embodiments, if the user selects an incorrect image, the game time sound will continue to play. In some embodiments, if a correct image is selected, another audio recording of another image will be played and the user will again need to select the image prior to a predetermined amount of time being elapsed. In some embodiments, each game comprises a predetermined number of audio recordings being played (emitted). In some embodiments, each game will randomly identify the audio recordings to play, such that no two games are the same. In some embodiments, the seek and find game may have one or more levels corresponding to a level of difficulty for the game. In some embodiments, increasing level of difficulty results in a shorter amount of time allowed for a user to select the corresponding image of an audio recording. In some embodiments, the predetermined amount of time for any level of the seek and find game is at most about 1 second, 2 seconds, 3 seconds, 5 seconds, 10 seconds, 20 seconds, 30 seconds, or 1 minute. A third button may be a race button, and it can allow the user to engage in a race with family members or friends to find the words within the shortest time. Additional buttons may be provided, such as buttons for turning up or down the volume of the played audio recordings, and a mute button for muting the audio recordings. In some embodiments, a play/pause button enables a game to be paused or resumed.

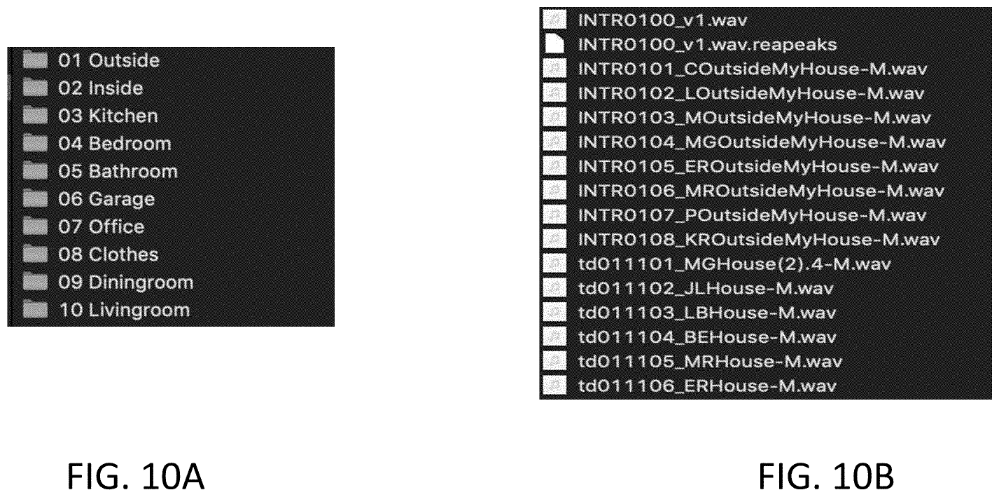

FIGS. 10A through 13 illustrate a programming guide for the audio file button assignments and game play included in the interactive book. First, variable assignments and sound files will be described with reference to FIGS. 10A and 10B. Referring to FIG. 10A, the sound files (audio recordings) can be organized in folders stored in memory. In some embodiments, the memory located on a printed circuit board (PCB). Each spread has its own folder that includes all the sounds for the spread. A spread may correspond to a theme on one or more pages. The book may include any number of spreads, and any number of pages. A spread may be, for example two pages opened side-by-side (one page on the left side, and the other page on the right side of the book). The themes may be related to one another. For example, spread 01 (page 01) may include sounds of words associated with the outside of a house; spread 02 (page 02) may include sounds of words associated with the inside of a house; spread 03 (page 03) may include sounds of words associated with the kitchen of the house; spread 04 (page 04) may include sounds of words associated with the bedroom; spread 05 (page 05) may include sounds of words associated with the bathroom, and so forth.

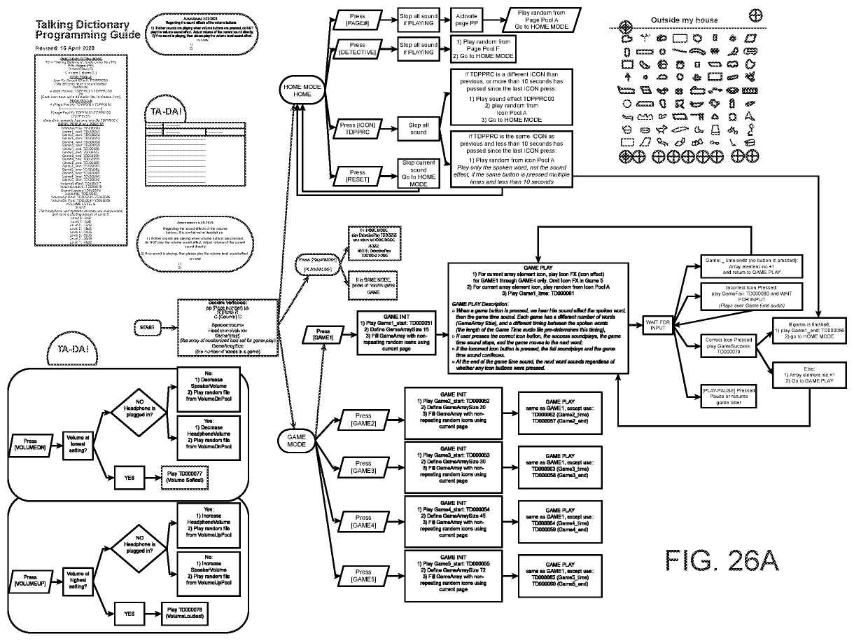

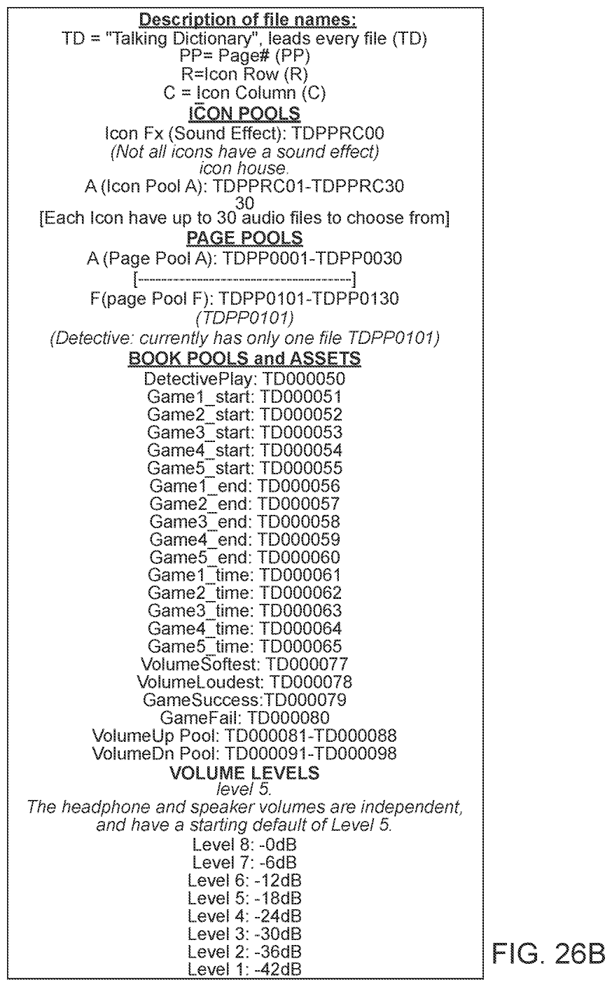

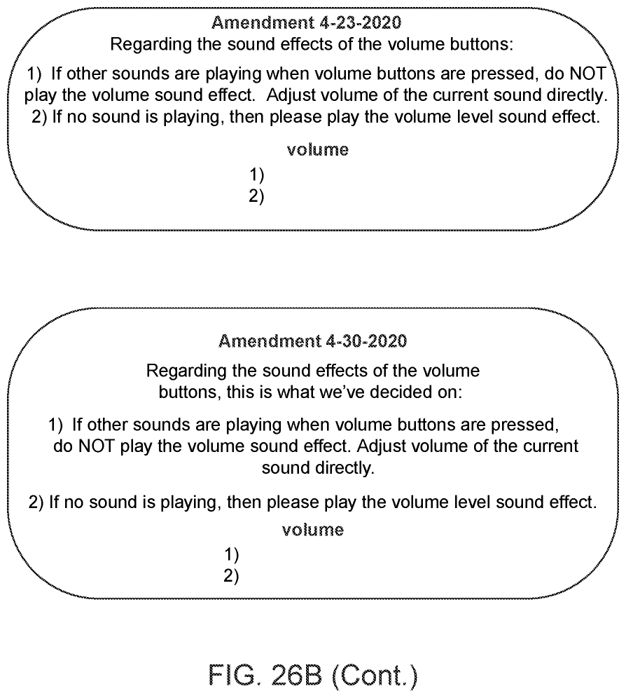

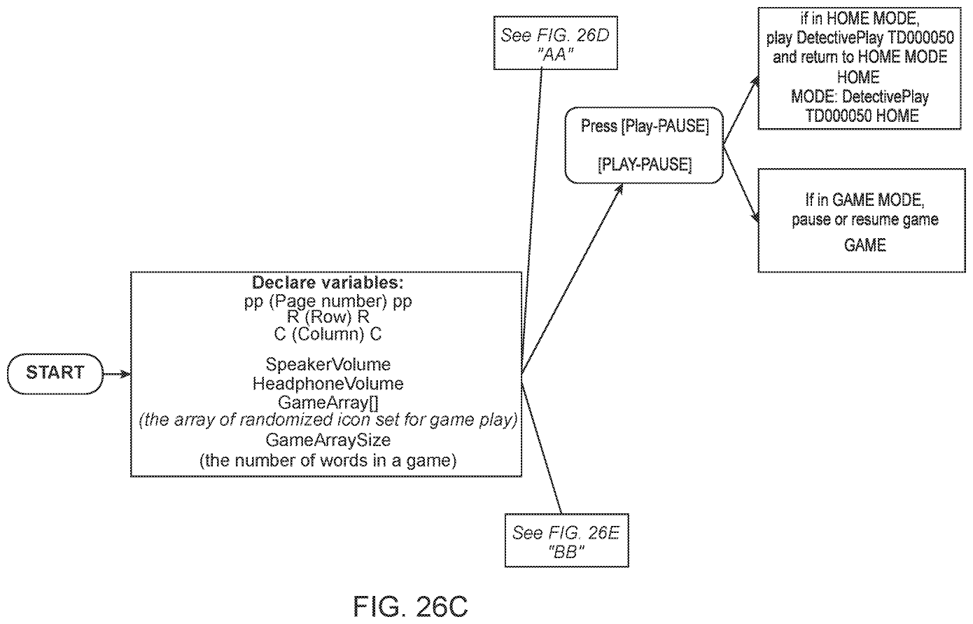

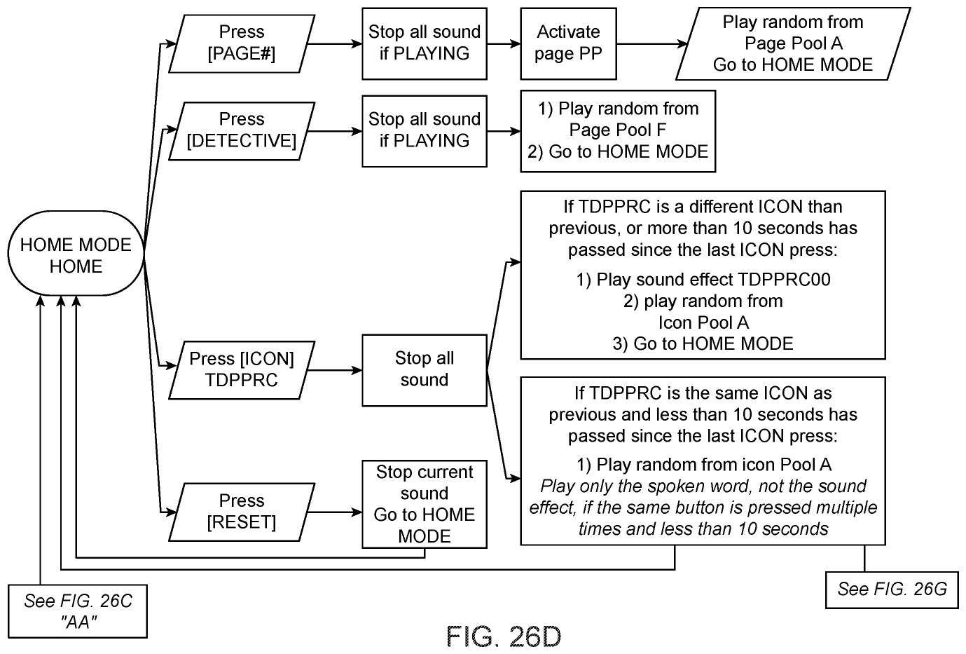

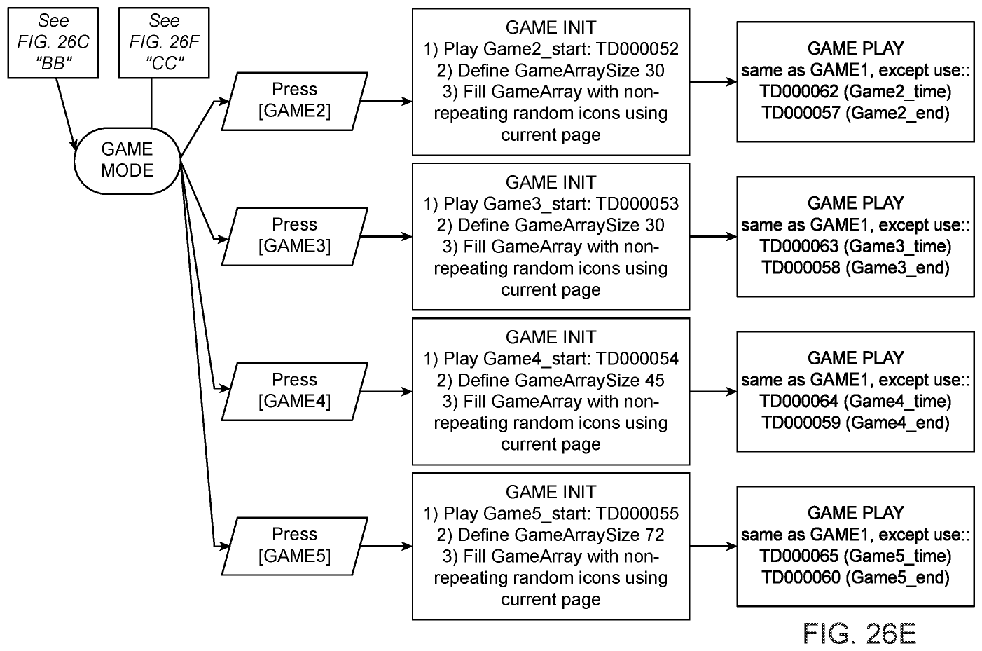

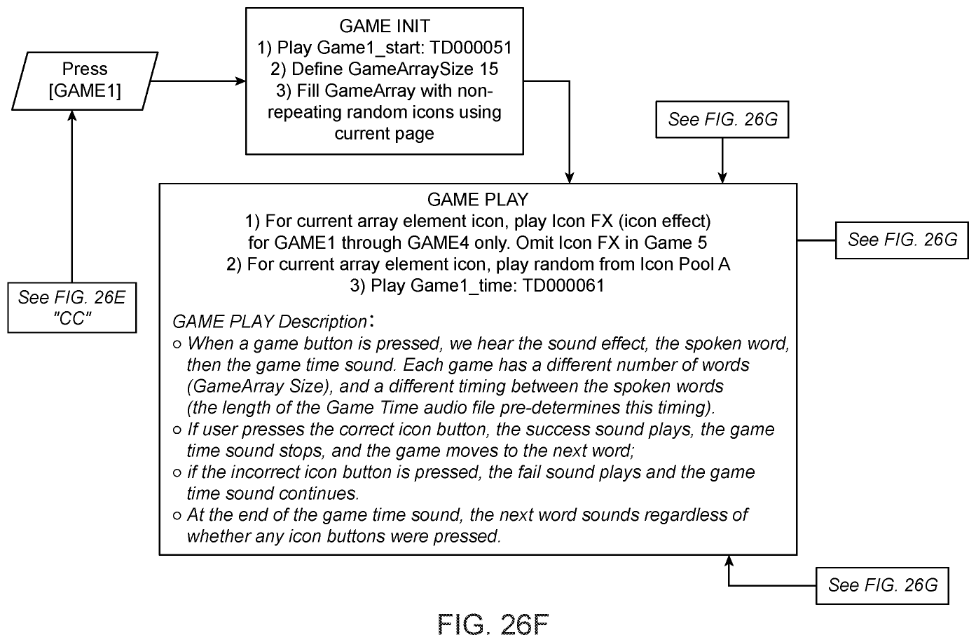

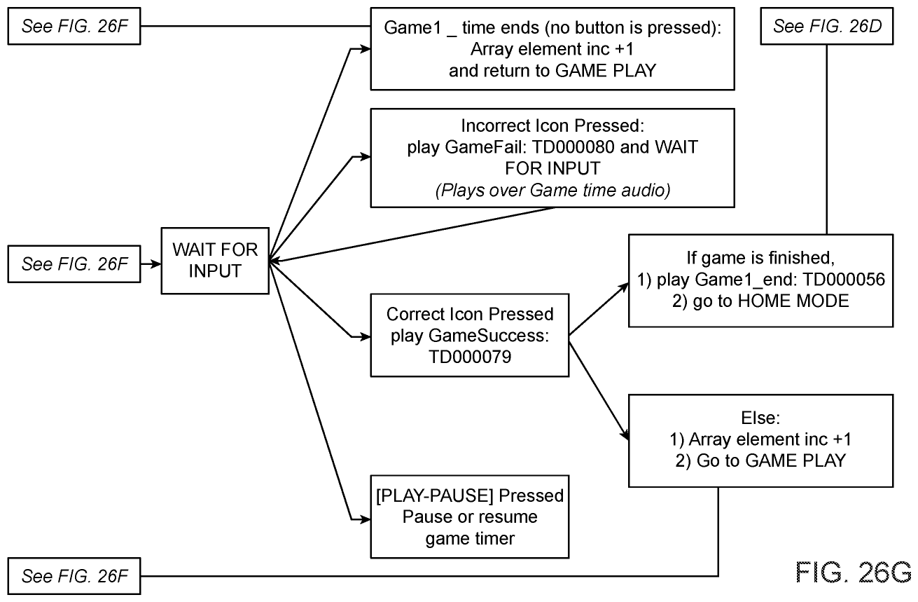

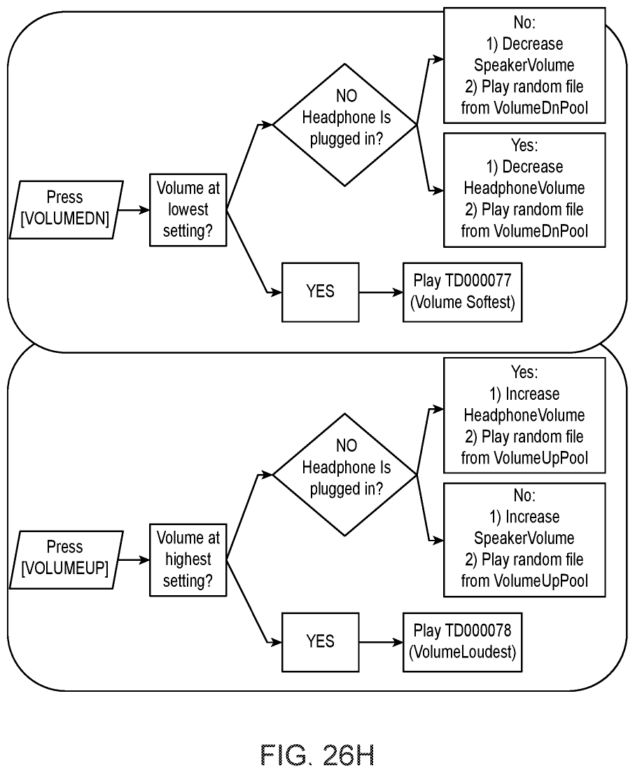

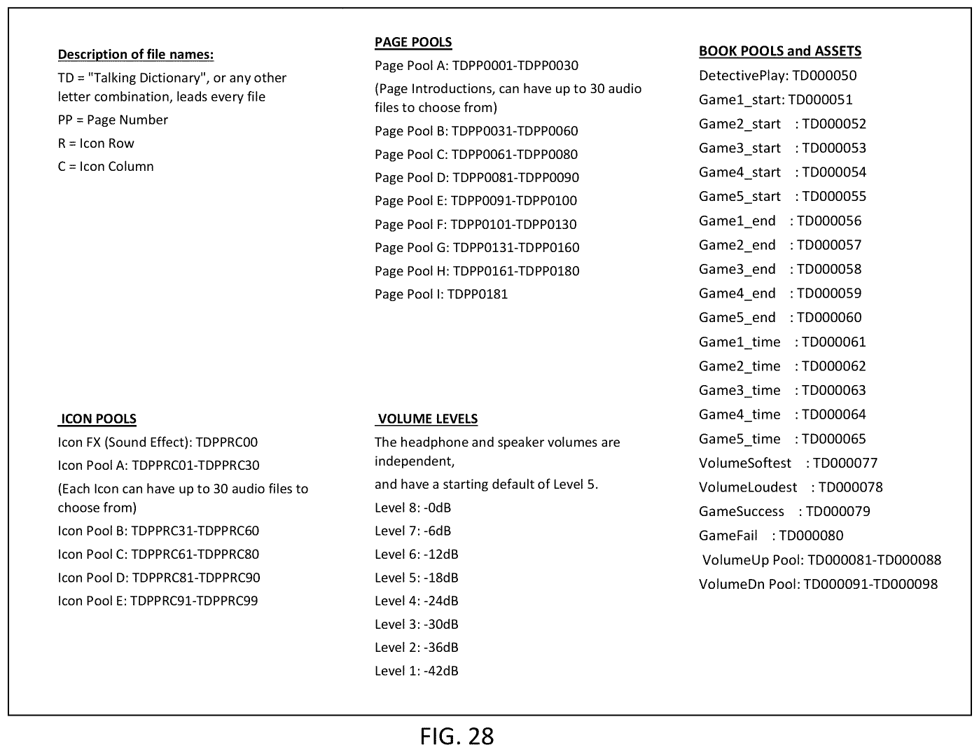

For the programming of the sounds, variable assignments can be used throughout the book, for example as shown in FIG. 28, which correspond to the programming flow chart from FIGS. 26A-H.

Each of the types of variables will be described in further detail elsewhere herein. FIG. 10B shows an example of a few of the sound files in a folder. The sound files may be provided in .wav, .mp3 or any other suitable audio formats.

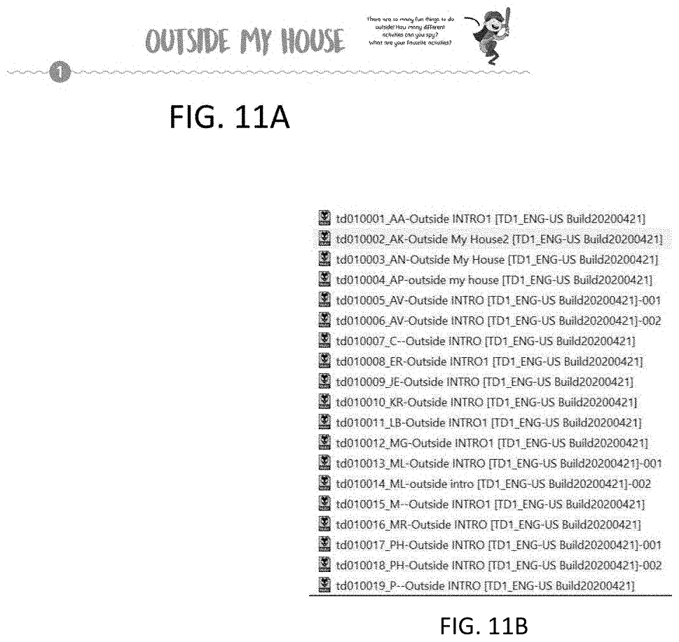

FIGS. 11A and 11B illustrate page select and introductions. A user can start by activating the corresponding page by pressing a number on the top of the page. In some embodiments, page numbers go from 1 to 10. In some embodiments, the page numbers go from 1 to 20. FIG. 11A shows an example of the first page (page 01). When pressing the page number, a page introduction sound effect, followed by a voice sound will be played. In some embodiments, a plurality of voice sounds is associated with a given image (for e.g., a plurality of voice sounds may be stored in the memory described herein). In some embodiments, the plurality of voice sounds comprise a plurality of human speakers each saying the word associated with the given image. The voice sound emitted when a page number is pressed may be predetermined or chosen randomly. The number of human speakers may be the same or may vary for every page. FIG. 11B shows an example of the first page (page 01) introduction sound effects and voice sounds for Outside My House, which is the spread/theme for page 01. An exemplary description and example of the programming execution for selecting a page number on the book, in some embodiments, is as provided in the table below:

Programming
Upon page selection press, play INTRpp00 followed by INTRpp##

| | |
|---|---|
| INTRpp00 | Page introduction sound effect |
| INTRpp## | Voice sound, chosen randomly. Number of human speakers varies per page |

Examples:
INTR0100_v1.wav
INTR|01|00|ZZ - page introduction sound effect for page 1, sound effect number 0, ZZ
represents additional characteristics (in the case_v1) which might not be relevant for
programming.
INTR0101_COutsideMyHouse-M.wav
INTR|01|01|ZZ - page introduction voice sound for page 1, voice sound number 1, ZZ
represents additional characteristics (in the case _COutsideMyHouse-M) which might not be
relevant for programming.

To use page 1 as an example, in some embodiments, when pressing the “1” or “01” button on the top of the page, a page introduction sound effect may be played based on a instructions sent to the audio module. For example, the instructions may comprise: “Play INTR0100 v1.wav”. In some embodiments, after the page introduction sound effect is emitted, a voice sound is then emitted. In some embodiments, one or more voice sounds is associated with a given page number. In some embodiments, a random voice sound of the one or more voice sounds is emitted. For example, for page 01, after the page introduction sound is emitted, the book will then randomly play one of the voice sounds as provided in FIG. 11B.

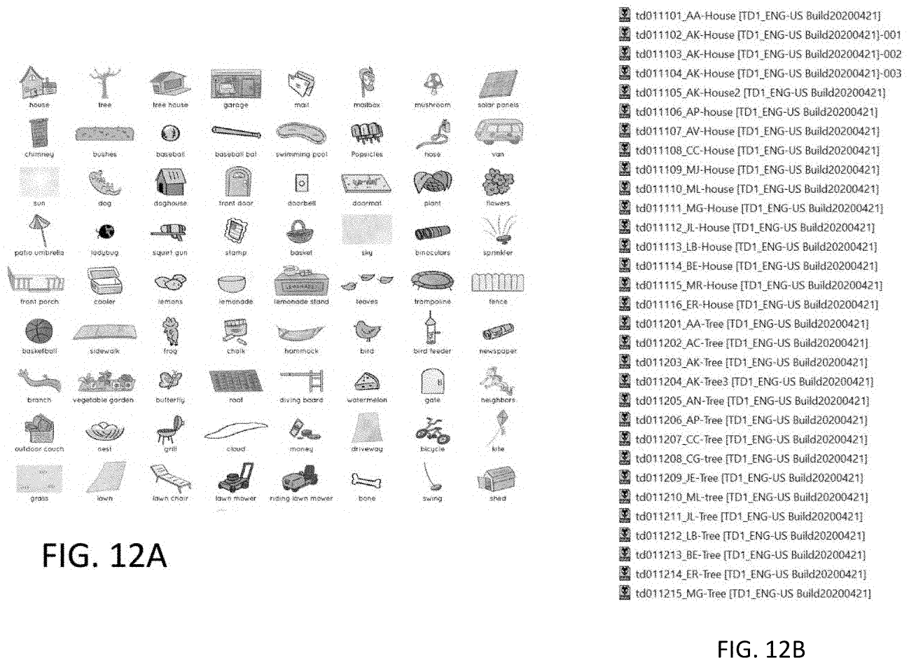

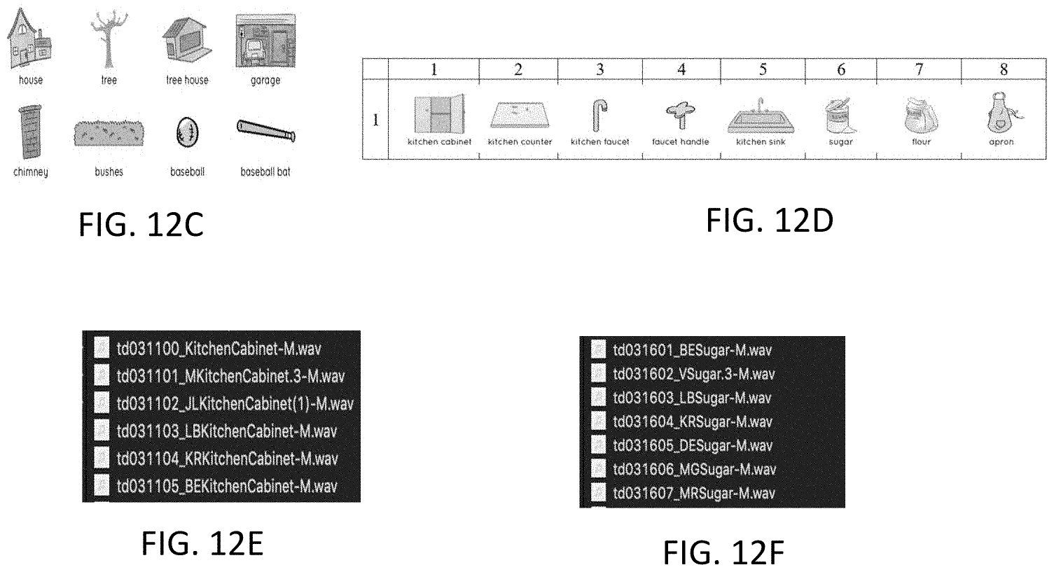

FIGS. 12A-12F illustrate the playing of different sounds associated with different images. FIG. 12A shows an example of the image grid layout for page 1, Outside My House. The images may be in a grid format, for example 9 rows by 8 columns. After having activated the page (for e.g., page 1), the user can then touch any of the images on page 1. In some embodiments, touching an image will result in an image sound effect being played (when available), followed by a randomly chosen voice sound for the image being emitted (played). In some embodiments, touching an image will result in a randomly chosen voice sound for the image. The number of human speakers (voice sounds) per image may be the same or may vary. In some embodiments, the number of human speakers per image is from about 1 to about 30.

FIG. 12B shows example sound files for the first image in row 1, column 1 (FIG. 12A), Outside My House. FIG. 12C shows an example for the word garage on page 1 (on row 1, column 4).

For the programming of the sounds associated with an image, variable assignments can be used throughout the book, for example as shown in the table below for the relevant variables:

TABLE 2
Programming Variables for Image Selection and Explanation

| Variable | Explanation |
|---|---|
| td | Every image file starts “td” with stands for |
| | TA-DA! |
| pp | Two-digit page number |
| r | Image row position (e.g., 1-9 in FIG. 12A) |
| | on the page |
| c | Image column position (e.g., 1-8 in FIG. |
| | 12A) on the page |
| 00 | Sound effect - the number 00 always refers to |
| | the sound effect. Not all images have a sound |
| | effect, so sometimes, there might not be a file |
| | with 00 for an image. |
| ## | Voice sounds (01-99). Some images have |
| | many voice sounds, others have few. Same |
| | with page select. |

An exemplary description and example of the programming execution for touching/pressing an image on a given page on the book, in some embodiments, is as provided in the table below:

TABLE 3
Exemplary Image Selection Programming and Examples

```
Programming
Upon image press, play tdpprc00 followed by tdpprc##
tdpprc00 Image sound effect. Not all icons have a sound effect.
tdpprc## Voice sound, chosen randomly. Number of human speakers varies per image.
In an example, if the image associated with a garage is selected (FIG. 12C):
  • td011400_Garage-M.wav
td|01|1|4|00|ZZ - image sound effect for page 1, row position 1, column position 4, sound
effect, ZZ represents additional characteristics (in the case _Garage-M) which might not be
relevant for programming.
  • td011401_MGGarage-M.wav
  • td011402_BEGarage-M.wav
td|01|1|4|01|ZZ - image voice sound for page 1, row position 1, column position 4, first voice
sound, ZZ represents additional characteristics (in the case _v1) which might not be relevant
for programming.
td|01|1|4|02|ZZ - image voice sound for page 1, row position 1, column position 4, second
voice sound, ZZ represents additional characteristics (in the case _v1) which might not be
relevant for programming.
```

FIG. 12D shows using page 3 (In My Kitchen), row 1 as an example. Referring to FIG. 12E, when the image ‘kitchen cabinet’ is pressed, the following operations may take place:

Play the image sound effect td031100 KitchenCabinet-M.way (if available), followed by randomly play one of the voice sounds as provided in FIG. 12E and the table below, (which are an exemplary set of voice sounds available):

TABLE 4
Exemplary Voice Sounds for an Image
on a Page of the Interactive Book

td031101_MKitchenCabinet.3-M.wav
td031102_JLKitchenCabinet(1)-M.wav
td031103_LBKitchenCabinet-M.wav
td031104_KRKitchenCabinet-M.wav
td031105_BEKitchenCabinet-M.wav

Referring to FIG. 12F, when the image “sugar” is pressed, the following operations take place: No sound effect: there is no ‘tdpprc00’ file for this image; randomly play one of the voice sounds as provided in FIG. 12F and the table below:

TABLE 5
Another Set of Exemplary Voice Sounds for
an Image on a Page of the Interactive Book

td031601_BESugar-M.wav
td031602_VSugar-M.wav
td031603_LBSugar-M.wav
td031604_KRSugar-M.wav
td031605_DESugar-M.wav
td031606_MGSugar-M.wav
td031607_MRSugsr-M.wav

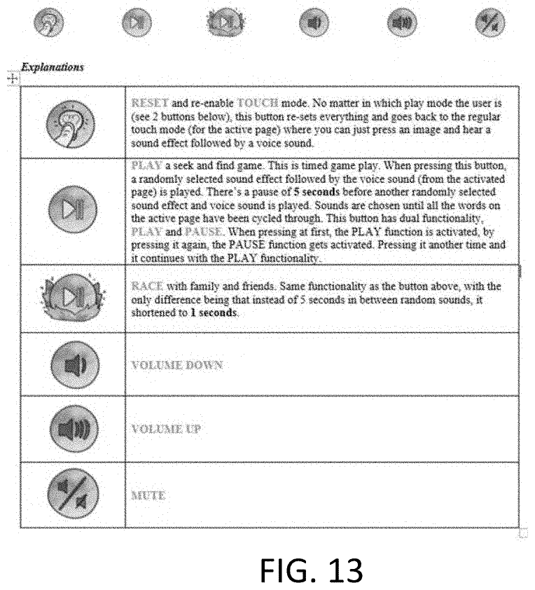

FIG. 13 illustrates an exemplary set of universal button controls for the interactive book and the respective functionality. In some embodiments, the bottom row on each page provides a number of universal buttons/controls. In some embodiments, the buttons can be actionable in the same way throughout the interactive book.

FIG. 26A provides an exemplary flow chart of the programming of the operation of the interactive book. FIGS. 26B-H provide expanded sections of the flow chart from FIG. 26A.

### Interactive Poster

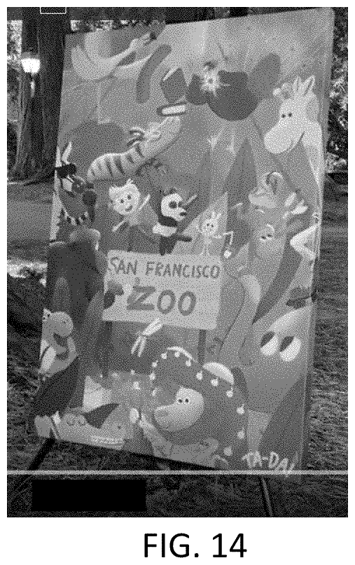

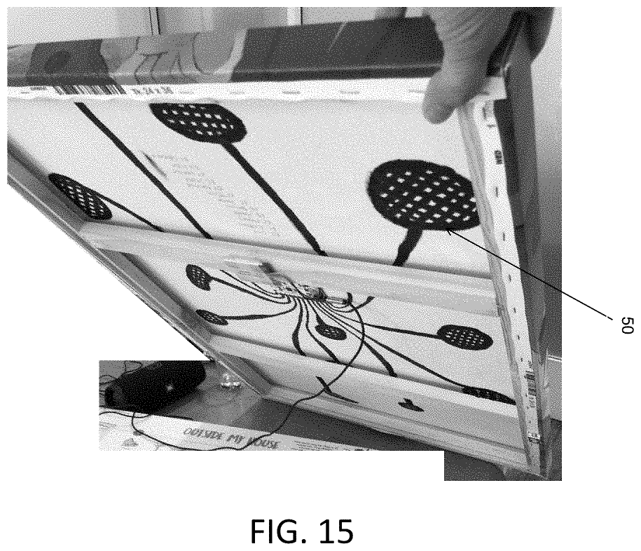

FIG. 14 illustrates an interactive poster in accordance with some embodiments, and FIG. 15 illustrates an example of the electrical circuitry/connections on the backside of the interactive poster. The interactive poster may be similar to the interactive book described elsewhere herein, except the poster is provided on a larger scale and typically comprises a single page or a few pages. The interactive poster may be made of paper or cardboard. A user (e.g. child or adult) can interact with the poster by touching on different images, words or sections on the poster. When the user touches a predefined section of the poster, an audio recording associated with that section may be played using a sound speaker located on the poster or in proximity to the poster. The sound speaker may be part of an audio module similar the ones describe elsewhere herein.

Referring to FIG. 15, the poster may include a plurality of touch sensors. The plurality of touch sensors may be located at the back of the poster or within the body of the poster. The touch sensors may be connected via circuitry. The circuitry may be arranged having a fan-out pattern, for example as shown in FIG. 15. The touch sensors may be formed having any shape and/or size. For example, the touch sensors may include a plurality of circular shaped pads 50, of a same size or different sizes, for enabling a variety of different sized touch areas. In some cases, the circuitry may be mounted on a printed circuit board or printed wiring board. In some embodiments, the touch sensors may be mounted directly on conductive printed circuitry or formed on a part of the poster, such as on the base or rear portion of the poster, using conductive glues or inks. In some embodiments, the touch sensors may comprise capacitive touch elements. The electrical traces may be formed using conductive ink, e.g. a silver-based conductive ink printed on a sheet. Other forms of conductive ink can be used, such as a copper-based conductive ink or some other metallic-based conductive ink, or a carbon-based conductive ink. The touch sensors and traces may be formed using a printing process, such as screen printing, ink jet printing, flexography or offset printing. The conductive traces can be used for connecting the touch sensors to an audio module, such that the appropriate audio recording is played when the corresponding image on the poster is touched.

In some embodiments, images or illustrations on the poster may be painted using electric paint. The electric paint can be used to paint and screen print circuits and sensors, or used as a conductive adhesive on different types of materials and surfaces including paper, plastic, textiles and conventional electronics. The electric paint can be insulated using standard acrylic or water-based paints for permanent applications or to create multi-layer circuitry. The electric paint can be used with touch boards to create large scale touch sensors suitable for posters. The electric paint may be non-toxic and water soluble, and can be used to paint or print sensors on a wide range of surfaces. These sensors can be used to build sensors into the environment or to create interactive installations. For long term durability, the electric paint can be sealed, coated or covered with a water-resistant layer such as acrylic or glass.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. An interactive paper-based book comprising:
(a) a back cover comprising a plurality of touch sensors and an audio module; and
(b) a plurality of paper pages that are stacked together on top of each other,
wherein each of the pages comprises a grid array of images associated with a plurality of words,
wherein the grid array of images on the plurality of pages are aligned with the plurality of touch sensors on the back cover,
wherein each of the pages and a set of audio files for each page are configured to be activated using a page button corresponding to the respective page, wherein the page buttons are located on one or more portions of the book, and
wherein the audio module is configured to play one or more sounds associated with an image on an activated page when the user touches the image on the activated page.

2. The interactive paper-based book of claim 1, wherein the plurality of touch sensors are disposed on a touch sensor substrate.

3. The interactive paper-based book of claim 1, wherein the plurality of touch sensors are in electrical communication with the audio module.

4. The interactive paper-based book of claim 3, wherein the plurality of touch sensors are in electrical communication with the audio module using conductive ink.

5. The interactive paper-based book of claim 4, wherein the conductive ink a metallic-based ink.

6. The interactive paper-based book of claim 4, wherein the conductive ink comprises silver-based conductive ink, copper-based ink, a carbon-based ink.

7. The interactive paper-based book of claim 1, wherein one or more touch sensors of the plurality of touch sensors comprises a capacitive touch element.

8. The interactive paper-based book of claim 1, wherein the audio module comprises a printed circuit board (PCB) or a flexible circuit board.

9. The interactive paper-based book of claim 1, wherein the audio module comprises a memory module and processor.

10. The interactive paper-based book of claim 1, wherein the audio module is configured to play the one or more sounds using a speaker disposed within the back cover.

11. The interactive paper-based book of claim 10, wherein the back cover comprises one or more speaker holes.

12. The interactive paper-based book of claim 11, wherein at least one speaker hole of the one or more speaker holes is not visible external to the back cover.

13. The interactive paper-based book of claim 12, wherein the speaker hole(s) that are not visible is configured to provide diaphragmatic resonance of the one or more sounds.

14. The interactive paper-based book of claim 1, wherein each page button corresponds to a touch sensor.

15. The interactive paper-based book of claim 1, wherein the one or more sounds are audio mastered.

16. The interactive paper-based book of claim 1, wherein the grid array comprises an “m”×“n” format, wherein “m” represents a predetermined number of rows, and “n” represents a predetermined number of columns.

17. The interactive paper-based book of claim 16, wherein the grid array comprises a square grid array, wherein the number of rows is equal to the number of columns.

18. The interactive paper-based book of claim 16, wherein the grid array comprises a rectangular grid array, wherein the number of rows is different from the number of columns.

19. The interactive paper-based book of claim 1, wherein the grid array comprises from about 5 rows to about 20 rows, and from about 4 columns to about 16 columns.

20. The interactive paper-based book of claim 1, wherein the plurality of paper pages comprises at least about 5 paper pages.
